(19) United States
(12) Patent Application Publication
(10) Pub. No.: US 2008/0076054 A1
(43) Pub. Date: Mar. 27, 2008

(54) Toner, production method thereof, toner container, developer, image forming apparatus and process cartridge using the same

(76) Inventors: Tsuyoshi Nozaki, Osaka (JP); Chiyoshi Nozaki, Otsu-shi (JP); Atsushi Yamamoto, Kawanishi-shi (JP); Mitsuyo Matsumoto, Osaka (JP); Katsunori Kurose, Takarazuka-shi (JP)

Correspondence Address: COOPER & DUNHAM, LLP, 1185 AVENUE OF THE AMERICAS, NEW YORK, NY, 10036, US

(21) Appl. No.: 11/900,023

(22) Filed: Sep. 7, 2007

(30) Foreign Application Priority Data
Sep. 8, 2006 (JP) 2006-243578

(51) Int. Cl. G03G 9/093

(52) U.S. Cl. 430/110.2; 430/137.11

(57) ABSTRACT

To provide a toner, having: a core and a shell which covers the core, wherein the core at least contains a colorant and a binder resin (A), the shell at least contains a binder resin (B) and a modified-layered inorganic mineral obtained by modifying at least a part of interlayer ions of a layered inorganic mineral with organic ions, the binder resin (A) at least contains a polyester resin, and the binder resin (B) at least contains a vinyl copolymer resin.

### BACKGROUND OF THE INVENTION

1. Field of the Invention

The present invention relates to a non-magnetic toner for developing electrostatic image and a production method for the toner, a developer using the toner, a toner container, an image forming apparatus and a process cartridge using the same.

2. Description of the Related Art

The research and development relating to electrophotography have been conducted with all kinds of ingenuity and technical approaches. In electrophotography, an image is formed by charging and exposing the surface of a photoconductor to form a latent electrostatic image, by developing the image using a color toner to thereby obtain a toner image, by transferring the toner image to a recording medium such as transfer paper, and by thermally fixing the thus transferred toner image with, for example, a thermo roll.

In such electrophotography, it is commonly known that, when toner particles are moved by, for example, an electric field force, the moving of the particles is significantly affected by the charged amount of toner and the distribution of the charged amount, thus adjustment on the electrostatic chargeability of the toner plays an important role.

For that reason, toners having a core/shell structure and so-called capsule toners have been proposed as means to obtain desired electrostatic chargeability.

For example, Japanese Patent Application Laid-Open (JP-A) No. 2005-084183 proposes a production method of a toner for electrostatic development. In the proposal, the toner has a core and coating layer made of polyester resin and vinyl resin respectively. The coating layer is formed on the surface of a colored resin particle obtained by emulsion dispersion, and is formed of resin particles that are obtained by an emulsion polymerization process using a surfactant or by an emulsion dispersion process using a surfactant.

JP-A No. 2004-295105 proposes aggregating dispersed particles of polyester resin and vinyl resin.

JP-A No. 2005-345862 proposes a technique to obtain capsulated particulates formed by polymerizing ethylene monomers at the surface or inside of polyester core particles.

Japanese Patent No. 3684103 proposes adjusting electrifiability by providing hydrotalcite on the surface of toner particles.

JP-A No. 2006-113553 proposes depositing resin particulates that contain an exchangeable anion compound on toner particles.

JP-A No. 2005-49858 proposes altering the form of toner particles by providing outer layers of the toner particles with a filer.

Further more, similar related-arts are proposed in JP-A Nos. 2003-515795, 2006-500605, 2006-503313 and 2003-202708.

In those related-arts, however, the main objectives are only on achieving uniform toner particle surfaces and averaging the electrostatic chargeabilities of the color toners, and thus the electrostatic chargeabilities are not drastically improved.

JP-B No. 3684103 proposes depositing hydrotalcite on toner bases, in addition to depositing normal inorganic particulates to the toner bases as a means of surface treatment, to thereby obtain desired electrostatic chargeability. In the proposed technique, however, it is difficult to form a sufficiently thinned layer from layered inorganic mineral (such as hydrotalcite) on the surface of toner particles. In addition, forming such layer in which a fine-dispersed state of layered inorganic mineral is obtained is also difficult. Thus, hydrotalcite may be aggregated. Furthermore, because such layer will not have sufficient strength as it is formed on the toner base particle after the particle is completely formed, thus it is difficult to prevent such toner particles from soiling surrounding members and affecting image quality.

Similarly, JP-A No. 2006-113553 proposes depositing resin particulates that contain an exchangeable anion compound on toner particles. In this method, however, the resin particulates will easily be separated from the toner particles, and thus the method not only cannot achieve a desired electrostatic chargeability in the toner but also soils surrounding members.

JP-A No. 2005-49858 proposes dispersing an already prepared resin-dispersed solution into a water-based medium, called a solution suspension method, to obtain toner particles. In the toner particles, an organic or inorganic filer is contained, and by locating the most of the filer in an outer area (or shell) of the toner particles, the shape of the toner particles are altered. In this method, however, when most of the filer exists in the outer area of the toner particles, the shape of the toner particles may be excessively altered. Thus, it is difficult to balance the existence of the filer with the shape of the toner particles.

Examples of the layered inorganic minerals include those disclosed in JP-A Nos. 2003-515795, 2006-500605, 2006-503313, 2003-202708.

### BRIEF SUMMARY OF THE INVENTION

An object of the present invention is to solve the forementioned problems and to provide a non-magnetic toner for developing an electrostatic image that has a sufficient electrostatic chargeability, an excellent durability and an excellent low temperature-fixing ability that is balanced with a heat-resistant storage property, and further to provide a production method for the toner, a developer using the toner, a toner container and an image forming apparatus.

The means for solving the forementioned problems are as follows:

<1>. A toner, including:

a core and a shell which covers the core,

wherein the core contains at least a colorant and a binder resin (A),

the shell contains at least a binder resin (B) and a modified-layered inorganic mineral obtained by modifying at least a part of interlayer ions of a layered inorganic mineral with organic ions,

the binder resin (A) contains at least a polyester resin, and

the binder resin (B) contains at least a vinyl copolymer resin.<2>. The toner according to <1>, wherein the shell is formed by aggregating and/or depositing and thermally fixing the modified-layered inorganic mineral and particulates containing the binder resin (B) on the core.<3>. The toner according to <1>, wherein the shell contains the modified-layered inorganic mineral obtained by modifying at least a part of the interlayer ions of the layered inorganic mineral with the organic ions.<4>. The toner according to <1>, wherein the modified-layered inorganic mineral is obtained by modifying at least a part of interlayer ions contained in one of silicates and hydrotalcites with the organic ions.<5>. The toner according to <1>, wherein the modified-layered inorganic mineral is obtained by modifying at least a part of interlayer ions of any one of montmorillonite, smectite and bentonite with organic cations.<6>.

The toner according to <5>, wherein the organic cations are quaternary-ammonium cations.<7>. The toner according to <2>, wherein the particulates were polymerized by emulsion polymerization, miniemulsion polymerization or suspension polymerization in an environment to which at least the modified-layered inorganic mineral and a polymerizable compound are added.<8>. The toner according to <1>, wherein the core is obtained by dissolving and/or dispersing at least the polyester resin and the colorant in an inorganic solvent and dispersing the thus obtained dissolved or dispersed article into an aquatic medium.<9>. The toner according to <1>, wherein the core contains a modified polyester resin which contains at least one of urethane and urea groups.<10>. The toner according to <1>, wherein the polyester resin contains one of a modified polyester resin having an isocyanate group at a terminal thereof and a modified polyester resin chain-elongated or cross-linked by reaction of amines.<11>. A production method for toner, including:

forming core particles by dispersing an organic solvent into which at least a polyester resin and a colorant are dissolved and/or dispersed into an aquatic medium,

depositing resin particulates of vinyl copolymer on the core particles by adding both an aquatic medium in which at least the resin particulates of vinyl copolymer and a modified-layered inorganic mineral are dispersed and a metal salt, and

heating the thus obtained toner particles.<12>. The production method according to <11>, wherein the core particles are formed by depositing and/or aggregating at least the resin particulates and the colorant in the aquatic medium, and thermally fixing the thus obtained particles.<13>. The production method according to <11>, wherein the glass transition temperature of a binder resin contained in the core particles is lower than the glass transition temperature of a binder resin contained in the shell.<14>. A developer, including a toner which includes:

a core and a shell which covers the core,

wherein the core contains at least a colorant and a binder resin (A),

the shell contains at least a binder resin (B) and a modified-layered inorganic mineral obtained by modifying at least a part of interlayer ions of a layered inorganic mineral with organic ions,

the binder resin (A) contains at least a polyester resin, and

the binder resin (B) contains at least a vinyl copolymer resin.

<15>. A toner container, including a toner which includes: a core and a shell which covers the core, wherein

the core contains at least a colorant and a binder resin (A),

the shell contains at least a binder resin (B) and a modified-layered inorganic mineral obtained by modifying at least a part of interlayer ions of a layered inorganic mineral with organic ions,

the binder resin (A) contains at least a polyester resin, and

the binder resin (B) contains at least a vinyl copolymer resin.<16>. An image forming apparatus, including:

a latent electrostatic image bearing member,

a latent electrostatic image forming unit configured to form a latent electrostatic image on the latent electrostatic image bearing member,

a developing unit configured to develop the latent electrostatic image into a visible image using a toner,

a transfer unit configured to transfer the visible image onto a recording medium, and

a fixing unit configured to fix the transferred image on the recording medium,

wherein the toner includes a core and a shell which covers the core,

the core contains at least a colorant and a binder resin (A),

the shell contains at least a binder resin (B) and a modified-layered inorganic mineral obtained by modifying at least a part of interlayer ions of a layered inorganic mineral with organic ions,

the binder resin (A) contains at least a polyester resin, and

the binder resin (B) contains at least a vinyl copolymer resin.<17>. The image forming apparatus according to <16>, wherein the fixing unit is equipped with a roller.<18>. The image forming apparatus according to <16>, wherein the fixing unit dose not apply oil.

<19>. A process cartridge, integrally including:

a latent electrostatic image bearing member, and

a developing unit configured to develop a latent electrostatic image formed on the latent electrostatic image bearing member into a visible image using a toner,

and further integrally including at least one selected from a charging unit, cleaning unit and charge-elimination unit,

wherein the process cartridge is detachably attached to an image forming apparatus,

the toner includes a core and a shell which covers the core,

the core contains at least a colorant and a binder resin (A),

the shell contains at least a binder resin (B) and a modified-layered inorganic mineral obtained by modifying at least a part of interlayer ions of a layered inorganic mineral with organic ions,

the binder resin (A) contains at least a polyester resin,

and the binder resin (B) contains at least a vinyl copolymer resin.

### BRIEF DESCRIPTION OF THE SEVERAL VIEWS OF THE DRAWINGS

FIG. 1 schematically shows an embodiment of the toner of the present invention.

FIG. 2 is a schematic view showing an embodiment of the image forming apparatus of the present invention, which contains the process cartridge of the present invention.

FIG. 3 schematically shows the fixing unit used in Examples.

### DETAILED DESCRIPTION OF THE INVENTION

(Toner)

The toner of the present invention at least contains a core and a shell which covers the core, wherein the core at least contains a colorant and a binder resin (A), and further contains other components in accordance with necessity.

The shell at least contains a binder resin (B) and a modified-layered inorganic mineral obtained by modifying at least a part of interlayer ions of layered inorganic mineral with organic ions, and further contains other components in accordance with necessity.

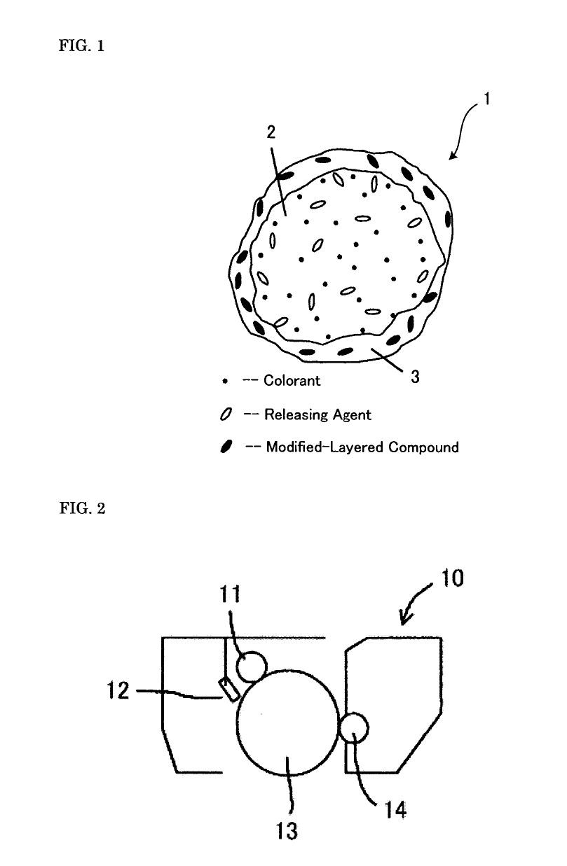

FIG. 1 shows an embodiment of the structure of the toner of the present invention.

As shown in FIG. 1, the toner particle 1 of the present invention contains at least a colorant, a core 2 containing a binder resin, and a shell 3 covering the core 2. The shell 3 is formed of resin particulates which at least contain a layered-inorganic mineral in which interlayer ions are exchanged with organic ions. The resin particulates are thermally fixed on the core 2 to form the shell 3. The toner particle of the present invention may further contain other components such as a releasing agent to improve the releasing property in heat-fixing, and a charge control agent, or CCA, to obtain desired electrostatic chargeability.

The resin particulates containing the modified-layered inorganic mineral are formed into the shell 3 preferably by thermally fixing the resin particulates deposited or aggregated on an already prepared core. Other components such as a colorant and a releasing agent may be added into the shell 3, while such components preferably do not exist at the outermost area of the toner particle for preventing contamination to other members and changes in properties of colorants. In addition, although the resin particulates may exist in the core, the modified-layered inorganic mineral contained in the resin particulates will little improve the electrostatic chargeability in such case.

The proportion of the shell to the total mass of the toner particles is preferably in the range of from 2% by mass to 40% by mass, more preferably in the range of from 5% by mass to 30% by mass and further preferably in the range of from 10% by mass to 20% by mass. When it is smaller than 2% by mass, the core will not be sufficiently covered with the shell, degrading its effects. And when it is more than 40% by mass, the effect of the shell will become excessive because the amount of the modified-layered inorganic mineral existing in the outer area decreases in the shell.

<Modified-Layered Inorganic Mineral>

The “modified-layered inorganic mineral” is obtained by modifying at least a part of interlayer ions of a layered inorganic mineral with organic ions. The term “layered inorganic mineral” refers to layers of an inorganic mineral formed by overlaying layers thereof having a thickness of several nm. The term “modify” or “modifying” refers to introducing organic ions into interlayer ions. Specifically, modified-layered inorganic minerals are proposed in JP-A Nos. 2006-113553, 2005-49858 and 2003-515795. This is referred to as intercalation in a broad sense. Examples of the layered inorganic minerals include silicates containing silicon oxide and hydrotalcites mainly composed of hydroxides of Al and Mg. Examples of the silicates include smectites. Examples of the smectites include montmorillonite, beidellite, hectorite, saponite and stevensite. Examples of minerals containing montmorillonite include bentonite. In addition, kaolins (such as kaolinite), magadiite and kanemite are known. The modified-layered inorganic mineral is highly hydrophilic due to its modified layered structure. Thus, when the resin particulates are formed by copolymerizing polymerizable monomers of unmodified layered inorganic mineral in an aquatic medium, sufficient amount of the layered inorganic mineral will not be contained in the resin particulates. This is because the layered inorganic mineral easily transfers into the aquatic medium. On the other hand, by using modified-layered inorganic mineral, or lowering hydrophilicity thereof, the layered inorganic mineral easily transfers into the polymerizable monomers. Then, the layered inorganic mineral will be sufficiently dispersed and miniaturized, enabling obtaining excellent charge control function. Additionally, when the modified-layered inorganic mineral is miniaturized in resin particulates being formed, the existence portion of the modified-layered inorganic mineral in the surface area of the resin particulates will be increased, providing improved electrostatic chargeability.

The modified-layered inorganic mineral is desirably obtained by modifying one having a smectite-based basic crystal structure with an organic cation. Metal anions can be introduced by substituting a part of a bivalent metal in the layered inorganic mineral with a trivalent metal. However, when the metal anion is introduced, the hydrophilicity increases. For this reason, a layered inorganic compound formed by modifying at least a part of the metal anions with organic anions should preferably used.

Examples of an organic ion modifier of the layered inorganic mineral in which at least a part of ions contained therein is modified with organic ions include quaternary alkyl ammonium salts, phosphonium salts and imidazolium salts. Of those salts, the quaternary alkyl ammonium salts are preferable.

Examples of the quaternary alkyl ammonium salts include trimethylstearyl ammonium, dimethylstearylbenzyl ammonium, dimethyloctadecyl ammonium and oleylbis(2-hydroxyethyl)methyl ammonium.

Examples of the organic ion modifier include sulfate salts, sulfonate salts, carboxylate salts or phosphate salts having, for example, branched, non-branched or cyclic alkyl (having 1 to 44 carbon atoms), alkynyl (having 1 to 22 carbon atoms), alkoxy (having 8 to 32 carbon atoms), hydroxyalkyl (having 2 to 22 carbon atoms), ethylene oxide or propylene oxide. Of those salts, carboxylates having an ethylene oxide structure are particularly preferable.

The modified-layered inorganic mineral in which a part of ions is exchanged with organic ions is not particularly limited, and in accordance with the purpose, it can be appropriately selected from, for example, montmorillonite, smectite, bentonite, hectorite, attapulgite, sepiolite and mixtures thereof. Of those minerals, organic modified montmorillonite and bentonite are particularly preferable as minerals that can greatly improve the electrostatic chargeability and durability when contained in the resin particulates.

Examples of commercially available products of layered inorganic mineral in which a part of ions are exchanged with organic cations include quaternium 18 bentonite such as Bentone 3, Bentone 38, Bentone 38V (all manufactured by Rheox Co.), Tixogel VP (manufactured by United Catalyst), Clayton 34, Clayton 40 and Clayton XL (all manufactured by Southern Clay); stearalconium bentonite such as Bentone 27 (manufactured by Rheox Co.), Tixogel LG (supplied from United Catalyst), Clayton AF and Clayton APA (all manufactured by Southern Clay); and quaternium 18/benzalkonium bentonite such as Clayton HT and Clayton PS (all manufactured by Southern Clay). Of those minerals, Clayton AF and Clayton APA are particularly preferable.

As the layered inorganic mineral in which a part of ions is exchanged with organic anions, those obtained by modifying DHT-4A (manufactured by Kyowa Chemical Industry Co., Ltd.) with the organic anions represented by the following general formula (1) are preferable.
R₁(OR₂)ₙOSO₃M General Formula (1)

Where R₁ represents an alkyl group having 13 carbon atoms and R₂ represents an alkylene group having 2 to 6 carbon atoms. “n” represents an integer of 2 to 10, and M represents a monovalent metal element.

Examples of the organic anion represented by the general formula (I) include HIGHTENOR 330T (manufactured by Dai-ichi Kogyo Seiyaku Co., Ltd.).

The shell is preferably formed by aggregating and thermally fixing the modified-layered inorganic mineral-containing particulates on the core. The particulates at least contain the modified-layered inorganic mineral and binder resin (B).

—Modified-Layered Inorganic Mineral-Containing Particulates—

Resins which can be used for producing the modified-layered inorganic mineral-containing particulates used for the toner are not particularly limited, and can be appropriately selected in accordance with the purpose. For example, when a polyester resin is used, desired resin particulates can be obtained by dissolving the polyester resin in an organic solvent, by dispersing a modified-layered inorganic mineral into the solvent with, for example, a dispersion machine, and by dispersing the thus obtained solvent into an aquatic medium. The above-stated method can also be used with another resin. If vinyl copolymer resin is used, the vinyl copolymer resin can easily be polymerized when modified-layered inorganic mineral is contained.

The vinyl copolymer resin particulates can easily be obtained by known process such as emulsion polymerization, miniemulsion polymerization and suspension polymerization. Resin particulates which may be used in the present invention and contain a modified-layered inorganic mineral can be preferably manufactured by the following process. For example, it may be obtained by adding a radical polymerizable vinyl monomer into a layered inorganic mineral-dispersed aquatic medium, by dispersing the monomer using, for example, a homogenizer such as TK FILLMIX (manufactured by PRIMIX Corporation) and CLEARMIX (manufactured by M-Technique Co.), and by adding a polymerization initiator into the thus dispersed dispersion. By adding an additional monomer after the first polymerization is completed, the layered-inorganic mineral can be contained in the resin particulates.

Before the thus obtained resin particulates are used for the toner, their property may or may not be adjusted by, for example, a decantation operation. By aggregating the particulates on a core, it is possible to form a shell that highly uniformly covers the core. Moreover, by thermally fixing the aggregated particulates, it is possible to cover the core with the shell with a higher uniformity, make the surfaces of the toner particles smooth and uniform, stabilize the charged amount distribution and improve the transfer efficiency The content of the modified-layered inorganic mineral in the resin particulates is preferably in the range of from 0.1% by mass to 30% by mass, and more preferably in the range of from 3% by mass to 15% by mass. When the content is less than 0.1% by mass, the sufficient effect of adding the modified-layered inorganic mineral may not be obtained. And when the content is more than 30% by mass, the modified-layered inorganic mineral may be aggregated in the resin particulates and/or manufacturing the resin particulates may become difficult.

<Binder Resin>

For fixing ability and heat-resistant storage property, polyester resins are used as binder resin (A) used for the core. In addition, vinyl copolymer resins are used because their characteristics such as heat characteristic and polar character can be easily determined, as well as because of easiness of copolymerizing the resins with a polymerizable monomer having special functional groups.

On the other hand, vinyl copolymer resins are used as binder resin (B) used for the core.

Polyester Resin

The polyester resins used in the present invention are not particularly limited and can be selected in accordance with the purpose. Examples thereof include any polycondensation product of polyols and polycarboxylic acids. Additionally, two or more polyester resins can be used in combination.

—Polyol—

Examples of the above-stated polyols include alkylene glycols, alkyleneether glycols, alicyclic diols, alkyleneoxide (such as ethyleneoxide, propyleneoxide and butyleneoxide) adducts of the alicyclic diol, bisphenols and alkyleneoxide (such as ethyleneoxide, propyleneoxide and butyleneoxide) adducts of the bisphenols.

Examples of the alkylene glycols include ethylene glycol, 1,2-propylene glycol, 1,3-propylene glycol, 1,4-butanediol and 1,6-hexanediol.

Examples of the alkyleneether glycols include diethylene glycol, triethylene glycol, dipropylene glycol, polyethylene glycol, polypropylene glycol and polytetramethylene ether glycol.

Examples of the alicyclic diols include 1,4-cyclohexanedimethanol and hydrogenated bisphenol A.

Examples of the bisphenols include bisphenol A, bisphenol F, bisphenol S; 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also called tetrafluoro bisphenyl A) and 2,2-bis(3-hydroxyphenyl)-1,1,1,3,3,3-hexafluoropropane; and bis(4-hydroxyphenyl)ethers such as bis(3-fluoro-4-hydroxyphenyl)ether.

Among them, alkylene glycol having 2 to 12 carbon atoms and the alkylene oxide adducts of bisphenols are preferable. Using the alkylene oxide adducts of bisphenols, and using the alkylene oxide adducts of bisphenols combination with alkylene glycol having 2 to 12 carbon atoms are particularly preferable.

In addition, trivalent to octavalent or more polyvalent aliphatic alcohol (glycerine, trimethylol ethane, trimethylol propane, pentaerythritol, sorbitol); trivalent or more phenols (trisphenol PA, phenol novolac, cresol novolac) and alkylene oxide adducts of the above trivalent or more polyphenols can be used. These may be used alone or in combination.

—Polycarboxylic Acid—

Examples of the above-stated polycarboxylic acids include alkylene dicarboxylic acids, alkenylene dicarboxylic acids and aromatic dicarboxylic acids.

Examples of the alkylene dicarboxylic acids include succinic acid, adipic acid and sebacic acid.

Examples of the alkenylene dicarboxylic acids include maleic acid and fumaric acid.

Examples of the aromatic dicarboxylic acids include phthalic acid, isophthalic acid, terephthalic acid, naphthalene dicarboxylic acid, 3-fluoro isophthalic acid, 2-fluoro isophthalic acid, 2-fluoro terephthalic acid, 2,4,5,6-tetrafluoro isophthalic acid, 2,3,5,6-tetrafluoro terephthalic acid, 5-trifluoromethyl isophthalic acid, 2,2-bis(4-carboxyphenyl)hexafluoropropane, 2,2-bis(4-carboxyphenyl)hexafluoropropane, 2,2-bis(3-carboxyphenyl)hexafluoropropane, 2,2′-bis(trifluoromethyl)-4,4′-biphenyl dicarboxylic acid, 3,3′-bis(trifluoromethyl)-4,4′-biphenyl dicarboxylic acid, 2,2′-bis(trifluoromethyl)-3,3′-biphenyl dicarboxylic acid and hexafluoroisopropylidene diphthalic acid anhydride.

Of those acids, alkenylene dicarboxylic acid having 4 to 20 carbon atoms and aromatic dicarboxylic acid having 8 to 20 carbon atoms are preferable. For trivalent or more polycarboxylic acids, aromatic polycarboxylic acids (such as trimellitic acid and pyromellitic acid) having 9 to 20 carbon atoms, anhydrides of the above-stated acids or lower alkylesters (such as methylester, ethyl esterand isopropylester) may be reacted with the polyol. These may be used alone or in combination.

As the ratio of the polyol to the polycarboxylic acid, or an equivalent ratio of hydroxyl groups [OH] to carboxyl groups [COOH] ([OH]/[COOH]), is preferably in the range of 2/1 to 1/1, more preferably in the range of 1.5/1 to 1/1 and further preferably 1.3/1 to 1.02/1.

The peak molecular weight of the polyester resin is preferably in the range of from 1,000 to 30,000, more preferably in the range of from 1,500 to 10,000, further preferably in the range of from 2,000 to 8,000. When the peak molecular weight is less than 1,000, the heat-resistant storage stability may be degraded, and when more than 30,000, the low temperature-fixing ability may be degraded.

—Modified Polyester Resin—

The binder resin (A) used for the core in the present invention may contain a modified polyester resin which contains urethane and/or urea groups, for adjusting viscoelasticity of the toner to prevent, for example, occurring of offset. The content of the modified polyester resin which contains at least one of an urethane group and an urea group is preferably 20% by mass or less, more preferably 15% by mass or less, and further preferably 10% by mass or less in the binder resin. When that is greater than 20% by mass, low temperature-fixing ability may be degraded.

the modified polyester resin which contains at least one of an urethane group and an urea group may be directly mixed into binder resin, while it is preferred that a modified polyester resin which contains at least one of an urethane group and an urea group be formed by mixing a modified polyester resin (it may be hereinafter called prepolymer) and amines reacting therewith into binder resin and by elongation and/or cross-linking reaction during and/or after the granulation. Thus, a modified polyester resin having a relatively high molecular weight can be easily contained in the core for adjusting the viscoelasticity of the toner.

The prepolymer having the isocyanate group can be obtained by, for example, further reacting the polyester which is a polycondensation product of the polyol and the polycarboxylic acid and has an active hydrogen group with a polyisocyanate. Examples of the active hydrogen group include hydroxyl groups (alcoholic hydrogen groups and phenolic hydroxyl groups), amino groups, carboxyl groups and mercapto groups. Among them, the alcoholic hydroxyl group is preferable.

Examples of the polyisocyanate include aliphatic polyisocyanates, alicyclic polyisocyanates, aromatic diisocyanates, aromatic aliphatic diisocyanates, isocyanurates and those obtained by blocking a polyisocyanate with, for example, phenol derivatives, oxime or caprolactam. Those can be used alone or in combination.

Examples of the aliphatic polyisocyanates include tetramethylene diisocyanate, hexamethylene diisocyanate and 2,6-diisocyanatomethylcaproate.

Examples of the alicyclic diisocyanates include isophorone diisocyanate, and cyclohexylmethane diisocyanate.

Examples of the aromatic diisocyanates include tolylene diisocyanate and diphenylmethane diisocyanate.

Examples of the aromatic-aliphatic diisocyanates include α,α,α′,α′-tetramethylxylylene diisocyanate.

The mixing ratio of the polyisocyanate is defined by the equivalent ratio of isocyanate groups [NCO] to hydroxyl groups [OH] of polyester, or [NCO]/[OH]. It is preferably in the range of from 5/1 to 1/1, more preferably in the range of 411 to 1.2/1, and further preferably in the range of 2.5/1 to 1.5/1. When the ratio [NCO]/[OH] is greater than 5, low temperature-fixing ability may be degraded. If the molar ratio of [NCO] is less than 1, the content of urea in the modified polyester becomes low, and it may result in degradation of the hot offset resistance.

The content of the structural component of the polyisocyanate in prepolymers which have isocyanate groups at their terminals is preferably in the range of from 0.5% by mass to 40% by mass, more preferably in the range of 1% by mass to 30% by mass and further preferably in the range of 2% by mass to 20% by mass. When the content is less than 0.5% by mass, the hot offset resistance may be degraded. And when the content is more than 40% by mass, the low temperature-fixing ability may be degraded.

The average number of the isocyanate groups contained in one prepolymer molecule of the above-sated prepolymers which have the isocyanate groups is preferably 1 or more, more preferably in the range of from 1.5 to 3, and further preferably in the range of from 1.8 to 2.5. When the number is less than one per molecule, the molecular weight of the urea-modified polyester becomes low after chain-elongation and/or cross-linking, and it may result in degradation of the hot offset resistance.

In the present invention, amines can be used as a chain elongating agent and/or a cross-linking agent. Amines (B) include diamines (B1), trivalent or more polyamines (B2), amino alcohols (B3), aminomercaptans (B4), amino acids (B5), and those (B6) obtained by blocking one of the amino groups, B1 to B5.

Examples of the above-stated diamines (B1) include aromatic diamines, alicyclic diamines and aliphatic diamines.

Examples of the aromatic diamines include phenylenediamine, diethyltoluenediamine, 4,4-diaminodiphenylmethane, tetrafluoro-p-xylylenediamine and tetrafluoro-p-phenylenediamine.

Examples of the alicyclic diamines include 4,4′-diamino-3,3′-dimethyldicyclohexylmethane, diaminocyclohexane and isophoronediamine.

Examples of the aliphatic diamines include ethylenediamine, tetramethylenediamine, hexamethylenediamine, dodecafluoro hexylene diamine and tetracosafluoro dode silenediamine.

Examples of the trivalent or more polyamines (B2) include diethylenetriamine and triethylenetetraamine.

Examples of the amino alcohols (B3) include ethanol amine and hydroxyethyl aniline.

Examples of the amino mercaptans (B4) include aminoethyl mercaptan and aminopropyl mercaptan.

Examples of the amino acids (B5) include aminopropionic acid and aminocaproic acid.

Examples of above-stated those (B6) obtained by blocking one of the amino groups, B1 to B5, include ketimine compounds and oxazolidine compounds obtained from amines of the above B1 to B5 and ketones (acetone, methyl ethyl ketone, methyl isobutyl ketone).

After chain elongation and/or cross-linking reactions, the molecular weight of the modified polyester can be adjusted using a terminator in accordance with necessity. Examples of the terminator includes monoamine (diethylamine, dibutylamine, butylamine, laurylamine) and those (ketimine compounds) obtained by blocking them.

The mixing ratio of the amines (B) is defined by the equivalent ratio of isocyanate groups [NCO] in prepolymers (A) to amino groups [NHx] of the amines (B), or [NCO]/[NHx]. It is preferably in the range of from 1/2 to 2/1, more preferably in the range of from 1.5/1 to 1/1.5, and further preferably in the range of from 1.2/1 to 1/1.2. When the ratio, [NCO]/[NHx], is larger than 2 or smaller than 1/2, the molecular weight of the urea-modified polyester becomes low, resulting in degradation of the hot offset resistance.

Vinyl Copolymer Resin

The vinyl copolymer resin is not particularly limited and can be selected from any resin. A vinyl polymerized resin may be used alone, or two or more vinyl copolymer resins may be used in combination.

The mass average molecular weight of the vinyl copolymer resin is preferably in the range of from 3,000 to 50,000, more preferably in the range of from 5,000 to 30,000, and further preferably in the range of from 7,000 to 20,000. When the mass average molecular weight is less than 3,000, problems such as fixation at an image developing apparatus may occur, and when more than 50,000, the low temperature-fixing ability may be degraded. The glass transition temperature of the vinyl copolymer resin is preferably in the range of from 40° C. to 80° C. and more preferably in the range of from 50° C. to 70° C. When the glass transition temperature is higher than 80° C., the low temperature-fixing ability may be degraded, and when lower than 40° C., the heat-resistant storage property may be degraded.

Examples of the vinyl copolymer resins include copolymerized vinyl monomers. Examples of the vinyl monomers include those described in (1) to (10) below.

(1) Vinyl Hydrocarbons

Examples of the vinyl hydrocarbons include aliphatic vinyl hydrocarbons, alicyclic vinyl hydrocarbons and aromatic vinyl hydrocarbons.

Examples of the aliphatic vinyl hydrocarbons include alkenes (such as ethylenes, propylenes, butenes, isobutylenes, pentenes, heptenes, diisobutylenes, octenes, dodecenes and octadecenes); α-olefins; and alkadienes (such as butadiene, isoprene, 1,4-pentadiene, 1,6-hexadiene and 1,7-octadiene).

Examples of the alicyclic vinyl hydrocarbons include mono-cycloalkene, di-cycloalkene, alkadienes (such as cyclohexene, (di)cyclopentadiene, vinylcyclohexene and ethylidene bicycloheptene), and terpenes (such as pinene, limonene and indene).

Examples of the vinyl hydrocarbons include styrenes, hydrocarvyl (such as alkyl, cycloalkyl, aralkyl and/or alkynyl) derivative substitutions of styrenes, and vinyl naphthalenes.

Examples of the styrenes and hydrocarvyl derivative substitutions thereof include α-methylstyrene, vinyltoluene, 2,4-dimethylstyrene, ethylstyrene, isopropylstyrene, butylstyrene, phenylstyrene, cyclohexylstyrene, benzylstyrene, crotylbenzene, divinylbenzene, divinyltoluene, divinylxylene and trivinylbenzene.

(2) Carboxyl Group-Containing Vinyl Monomers and Salt Thereof Examples of the carboxyl group-containing vinyl monomers and salts thereof include unsaturated monocarboxylic acids having 3 to 30 carbon atoms, unsaturated dicarboxylic acids, and anhydrides and monoalkyl (carbon atoms of 1 to 24) ester of such acids.

More specific examples include (meta)acrylic acid, (anhydride)maleic acid, monoalkylester of maleic acids, fumaric acids, monoalkylester of fumaric acids, crotonic acids, itaconic acids, monoalkylester of itaconic acid, glycol monoether of itaconic acids, citraconic acids, monoalkylester of citraconic acids and cinnamic acids.

(3) Sulfone Group-Containing Vinyl Monomers, Monoesterified Vinylsulfate Compounds, and Salts Thereof Examples of such monomers, compounds and salts include alkene sulfonates having 2 to 14 carbon atoms, alkyl derivatives thereof having 2 to 24 carbon atoms, sulfo(hydroxy)alkyl-metaacrylate and sulfo(hydroxy)alkyl-(meta)acrylamides.

Examples of the alkene sulfonates having 2 to 14 carbon atoms include vinylsulfonates, (meta)allylsulfonates, methyl vinyl sulfonates and styrene sulfonates.

Examples of the alkyl derivatives of alkene sulfonates (having 2 to 14 carbon atoms), which have 2 to 24 carbon atoms, include α-methylstyrene sulfonates.

Examples of the sulfo(hydroxy)alkyl-(metha)acrylates and sulfo(hydroxy)alkyl-(meta)acrylamides include sulfopropyl(metha)acrylate, 2-hydroxy-3-(meta)acryloxypropyl sulfonate, 2-(meta)acryloyl amino-2,2-dimethylethane sulfonate, 2-(meta)acryloyl oxyethane sulfonate, 3-(meta)acryloyloxy-2-hydroxy propanesulfonate, 2-(meta)acrylamide-2-methylpropanesulfonate, 3-(meta)acrylamide-2-hydroxy propanesulfonate, alkyl(with 3 to 18 carbon atoms)allyl sulfo succinic acid, sulfuric esters (such as poly(n of 5 to 15)oxypropylene monomethacrylate sulfuric ester) of poly (n of 2 to 30) oxyalkylene (it may be homopolymers, random polymers or block polymers of ethylene, propylene and/or butylene)mono(metha)acrylate and polyoxyethylene polycyclic phenylether.

(4) Phosphate Group-Containing Vinyl Monomers and Salts Thereof

Examples of the phosphate group-containing vinyl monomers and salts thereof include (meta)acryloyl oxyalkyl phosphate monoesters and (meta)acryloyl oxyalkyl (with 1 to 24 carbon atoms) phosphonic acids.

Examples of the (meta)acryloyl oxyalkyl phosphate monoesters include 2-hydroxyethyl(meta)acryloyl phosphate, phenyl-2-acryloyl oxyethyl phosphate and salts thereof.

Examples of the (meta)acryloyl oxyalkyls (with 1 to 24 carbon atoms) phosphonic acids include 2-acryloyl oxyethyl phosphonic acid and salts thereof.

Examples of salts of (2) to (4) include alkali metal salts (such as sodium salts and kalium salts), alkaline earth metal salts (such as calcium salts and magnesium salts), ammonium salts, amine salts and quaternary ammonium salts.

(5) Hydroxyl Group-Containing Vinyl Monomers

Examples of the hydroxyl group-containing vinyl monomers include hydroxy styrene, N-methylol(metha)acrylamide, hydroxyethyl(metha)acrylate, hydroxypropyl(metha)acrylate, polyethyleneglycol mono(metha)acrylate, (meta)allylalcohol, crotyl alcohol, isocrotyl alcohol, 1-butene-3-ol, 2-butene-1-ol, 2-butene-1,4-diol, propargyl alcohol, 2-hydroxyethyl propenylether and sucrose allylether.

(6) Nitrogen-Containing Vinyl Monomers

Examples of the nitrogen-containing vinyl monomers include amino group-containing vinyl monomers, amide group-containing vinyl monomers, nitrile group-containing vinyl monomers and quaternary ammonium cation group—containing vinyl monomers.

Examples of the amino group-containing vinyl monomers include aminoethyl(metha)acrylate, dimethylaminoethyl(metha)acrylate, diethylaminoethyl(metha)acrylate, t-butyl aminoethyl methacrylate, N-aminoethyl(meta)acrylamide, (meta)allylamine, morpholinoethyl(metha)acrylate, 4-vinylpyridine, 2-vinylpyridine, crotylamine, N,N-dimethylaminostyrene, methyl-α-acetaminoacrylate, vinyl imidazole, N-vinylpyrrole, vinyl thiopyrolidone, N-aryl phenylene diamine, amino carbazole, amino thiazole, amino indole, amino pyrrol, amino imidazole, amino mercapto thiazole and salts thereof.

Examples of the amide group-containing vinyl monomers include (meta)acrylamide, N-methyl(meta)acrylamide, N-butyl acrylamide, di acetone acrylamide, N-methylol(metha)acrylamide, N,N-methylene-bis(meta)acrylamide, cinnamic acid amide, N,N-dimethylacrylamide, N,N-dibenzylacrylamide, methacryl formamide, N-methyl-N-vinylacetamide and N-vinylpyrrolidone.

Examples of the nitrile group-containing vinyl monomers include (meta)acrylonitrile, cyanostyrene and cyanoacrylate.

Examples of the ammonium cation group-containing vinyl monomers include quaternized compounds (quaternized using a quaternizing agent such as methyl chloride, dimethyl sulfate, benzyl chloride and dimethyl carbonate) of tertiary amine group-containing vinyl monomers such as dimethylamino ethyl(meta)acrylate, diethylaminoethyl(meta)acrylate, dimethylamino ethyl(meta)acrylamide, diethylaminoethyl(meta)acrylamide and diallylamine.

Examples of the nitro group-containing vinyl monomers include nitrostyrenes.

(7) Epoxy Group-Containing Vinyl Monomers Examples of the epoxy group-containing vinyl monomers include glycidyl(meta) acrylate, tetrahydrofurfuryl(meta)acrylate and p-vinylphenylphenyloxide.

(8) Vinylesters, Vinyl(thio)ethers, Vinylketones and Vinylsulfones.

Examples of the vinylesters include vinyl acetate, vinyl butyrate, vinyl propionate, vinyl butyrate, diallylphthalate, diallyladipate, isopropenyl acetate, vinyl methacrylate, methyl-4-vinyl benzoate, cyclohexyl methacrylate, benzyl methacrylate, phenyl(meta)acrylate, vinyl methoxyacetate, vinyl benzoate, ethyl-alpha-ethoxy acrylate, alkyl(meta)acrylates (such as methyl(meta)acrylate, ethyl(meta)acrylate, propyl(meta)acrylate, butyl(meta)acrylate, 2-ethylhexyl(meta)acrylate, dodecyl(meta)acrylate, hexadecyl(meta)acrylate, heptadecyl(meta)acrylate and eicosyl(meta)acrylate) having alkyl groups which have 1 to 50 carbon atoms, dialkylfumarate (whose two alkyl groups have 2 to 8 carbon atoms and are straight chained or branched or alicyclic), dialkylmaleate (whose two alkyl groups have 2 to 8 carbon atoms and are straight chained or branched or alicyclic), poly(meta)allyloxy alkanes (such as di-allyloxyethane, tri-allyloxyethane, tetra-allyloxyethane, tetra-allyloxypropane, tetra-allyloxybutane, tetra-meta allyloxyethane), vinyl monomers (such as polyethyleneglycol (molecular weight of 300)mono-(meta)acrylate, polypropylene glycol (molecular weight of 500)mono-acrylate, (meta)acrylate with 10 mol of methylalcohol ethyleneoxide added and (meta)acrylate with 30 mol of lauryl alcohol ethyleneoxide added) having poly alkyleneglycol chains, and poly(meta)acrylates (such as poly(meta)acrylates of polyalcohols, ethyleneglycol di(meta)acrylate, propyleneglycol di(meta)acrylate, neopentylglycol di(meta) acrylate, trimethylolpropanetri(meta)acrylate and polyethyleneglycol di(meta) acrylate).

Examples of the vinyl(thio)ethers include vinyl methyl ether, vinyl ethyl ether, vinyl propyl ether, vinyl butyl ether, vinyl-2-ethyl hexylether, vinyl phenyl ether, vinyl-2-methoxyethyl ether, methoxybutadiene, vinyl-2-butoxyethyl ether, 3,4-dihydro-1,2-pyrane, 2-butoxy-2′-vinyloxy diethyl ether, vinyl-2-ethylmercaptoethyl ether, acetoxystyrene and phenoxystyrene.

Examples of the vinylketones include vinyl methyl ketone, vinyl ethyl ketone and vinyl phenyl ketone.

Examples of the vinylsulfones include divinyl sulfide, p-vinyl phenyl sulfide, vinyl ethyl sulfide, vinyl ethyl sulfone, divinyl sulfone and divinyl sulfoxide.

(9) Other Vinyl Monomers

Examples of the other vinyl monomers include isocyanate ethyl(meta)acrylate and m-isopropenyl-α,α-dimethylbenzyl isocyanate.

(10) Fluorine Atom-Containing Vinyl Monomers

Examples of the fluorine atom-containing vinyl monomers include 4-fluorostyrene, 2,3,5,6-tetrafluorostyrene, pentafluorophenyl(meta)acrylate, pentafluorobenzyl(meta)acrylate, perfluorocyclohexyl(meta)acrylate, perfluorocyclohexylmethyl(meta)acrylate, 2,2,2-trifluoroethyl(meta)acrylate, 2,2,3,3-tetrafluoropropyl(meta)acrylate, 1H, 1H,4H-hexafluorobutyl(meta)acrylate, 1H, 1H,5H-octafluoropentyl(meta)acrylate, 1H, 1H, 7H-dodecafluoroheptyl(meta) acrylate, perfluorooctyl(meta)acrylate, 2-perfluorooctylethyl(meta)acrylate, heptadecafluorodecyl(meta)acrylate, trihydroperfluoroundecyl(meta)acrylate, perfluoro nolbornylmethyl(meta)acrylate, 1H-pel fluoroisobornyl(meta)acrylate, 2-(N-butyl perfluorooctanesulfonamide)ethyl(meta)acrylate, 2-(N-ethyl perfluorooctanesulfonamide)ethyl(meta)acrylate, derivative compounds of □-fluoroacrylic acids, bis-hexa fluoroisopropyl itaconate, bis-hexa fluoroisopropyl maleate, bis-perfluorooctylitaconate, bis-perfluorooctyl maleate, bis-trifluoroethyl itaconate, bis-trifluoroethyl maleate, vinyl-polymersheptafluoro butyrate, vinyl perfluoroheptanoate, vinyl perfluorononanoate and vinyl perfluorooctanoate.

Examples of the copolymers of the vinyl monomers include polymers copolymerized with a given portion of two or more polymers selected from any one of (1) to (10). More specifically, examples of such polymers include copolymers of styrene-(meta)acrylic ester, copolymers of styrene-butadiene, copolymers of (meta)acrylic acid-acrylic acid ester, styrene-acrylonitrile copolymers, copolymers of styrene-maleic anhydride, copolymers of styrene-(meta)acrylic acid, styrene-(meta)acrylic acids, divinylbenzene copolymers and copolymers of styrene-styrene sulfonate-(meta)acrylic ester.

When the core is obtained by a so-called aggregation method, it is preferred that the vinyl copolymer resin to be used in the method be dispersed in an aquatic medium. The resin particulates of vinyl copolymer can easily be obtained by known method such as emulsion polymerization. Other components such as a releasing agent may also be dispersed in the aquatic medium so that it is contained in the resin particulates. In addition, an already dispersed solution (such as a releasing agent) may be added into the aquatic medium and aggregated with the particulates.

<Colorant>

As the colorant used in the present invention, all dyes and pigments publicly known can be used. For example, carbon black, nigrosine dyes, iron black, naphthol yellow S, hanza yellow (10G, 5G, G), cadmium yellow, yellow iron oxide, yellow ocher, chrome yellow, titanium yellow, polyazo yellow, oil yellow, hanza yellow (GR, A, RN, R), pigment yellow L, benzidine yellow (G, GR), permanent yellow (NCG), Balkan fast yellow (5G, R), tartrazine lake, quinoline yellow lake, anthrazane yellow BGL, isoindolinone yellow, colcothar, red lead, lead vermillion, cadmium red, cadmium mercury red, antimony vermillion, permanent red 4R, parared, faicer red, parachloroorthonitroaniline red, lithol fast scarlet G, brilliant fast scarlet, brilliant carmine BS, permanent red (F2R, F4R, FRL, FRLL, F4RH), fast scarlet VD, Balkan fast rubine B, brilliant scarlet G, lithol rubine GX, permanent red F5R, brilliant carmine 6B, pigment scarlet 3B, Bordeaux 5B, toluidine maroon, permanent Bordeaux F2K, helio Bordeaux BL, Bordeaux 10B, bon maroon light, bon maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, non-metallic phthalocyanine blue, phthalocyanine blue, fast sky blue, indanthrene blue (RS, BC), indigo, ultramarine blue, Prussian blue, anthraquinone blue, fast violet B, methyl violet lake, cobalt violet, manganese violet, dioxane violet, anthraquinone violet, chrome green, zinc green, chromium oxide, pyridian, emerald green, pigment green B, naphthol green B, green gold, acid green lake, malachite green, phthalocyanine green, anthraquinone green, titanium oxide, zinc flower, lithopone and mixtures thereof can be used. These may be used alone or in combination.

The content of the colorant is preferably in the range of from 1% by mass to 15% by mass, and more preferably in the range of from 3% by mass to 10% by mass per the total mass of the toner particles.

The colorant may be used as a master batch in which the colorant is complexed with a resin. The binding resin used for the production of the master batch or kneaded with the master batch includes, in addition to modified and unmodified polyester resins described above, polymers of styrene such as polystyrene, poly p-chlorostyrene and polyvinyl toluene and substituents thereof, styrene based copolymers such as styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl -chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleate ester copolymers; polymethyl methacrylate, polybutyl methacrylate, polyvinyl chloride, polyvinyl acetate, polyethylene, polypropylene, polyester, epoxy resins, epoxy polyol resins, polyurethane, polyamide, polyvinyl butyral, polyacrylic acid resins, rosin, modified rosin, terpene resins, aliphatic or alicyclic hydrocarbon resins, aromatic petroleum resins, chlorinated paraffin and paraffin wax, which can be used alone or in mixture. These may be used alone or in combination.

The above-stated master batch can be obtained by mixing the resin for the master batch with the colorant with applying a high shearing force and kneading the mixture. At that time, an organic solvent can be used to enhance the interaction between the colorant and the resin. The method referred to as so-called flashing method—in which a water-based paste of the colorant containing water is mixed and kneaded with the resin and the organic solvent, the colorant is transferred to the resin side and the water and the organic solvent components are removed—is preferably used because a wet cake of the colorant can be directly used and thus it is not necessary to dry. To mix and knead, a high shearing dispersion apparatus such as three roll mill is preferably used.

The other components are not particularly limited, and can be appropriately selected according to the purpose. Examples thereof include releasing agents, charge control agents, external additives and cleaning property enhancers.

—Releasing Agent—

The releasing agents are not particularly limited, and can be selected from known agents according to the purpose. Examples thereof include polyolefin waxes (such as polyethylene waxes and polkypropylene waxes), long chain hydrocarbons (such as paraffin waxes and SASOL Wax) and carbonyl group containing waxes.

Examples of the carbonyl group contained waxes include poly alkanoic acid ester, polyalkanol ester, polyalkanoic acid amide, polyalkylamide and dialkylketone. Among these, poly alkanoic acid ester is particularly preferable. Examples of the poly alkanoic acid esters include carnauba waxes, montan waxes, trimethylolpropane tribehenate, pentaerythritol tetrabehenate, pentaerythritol diacetate dibehenate, glycerine tribehenate and 1,18-octadecanediol distearate.

Examples of the polyalkanol esters include trimellitic acid stearyl and distearylmaleate.

Examples of the polyalkanoic acid amides include ethylene diamine dibehenylamide.

Examples of the polyalkylamides include trimellitic acid stearylamide.

Examples of the dialkylketones include distearylketone.

—Charge Control Agent—

The charge control agent is not particularly limited and can be appropriately selected in accordance with the purpose, while it is preferably selected from materials having an achromatic or white color when selected from organic materials. Examples thereof include triphenylmethane-based dyes, molybdate ion chelate pigments, rhodamine-based dyes, alkoxy amines, quaternary ammonium salts (including fluorine-modified quaternary ammonium salts), alkylamides, chemical elements or compounds of phosphorus, chemical elements or compounds of tungsten, fluorine-based activators, metal salts of salicylic acid, and metal salts of salicylic acid derivatives. These may be used alone or in combination.

The charge control agent may be selected from commercial available products including Bontron P-51, a quaternized ammonium salt; E-82, oxynaphthoic acid metal complex; E-84, salicylic acid metal complex; E-89, a phenol condensate (all manufactured by Orient Chemical Industries, Ltd.); TP-302 and TP-415, molybdic complexes of quaternized ammonium salt (manufactured by Hodogaya Chemical Co., Ltd.); Copycharge PSY VP2038 of a quaternized ammonium salt; Copyblue PR of a triphenylmethane derivative; Copycharge NEG VP2036 and NX VP434 of quaternized ammonium salts (all manufactured by Hoechst Co.); LRA-901 and LR-147, boron complexes (manufactured by Japan Carlit Co., Ltd.); copper phthalocyanine; perylene; quinacridone; azo pigment; and high polymer compounds having functional groups such as sulfonate groups, carboxyl groups and quaternized ammonium salts.

The charge control agent may be melted and kneaded together with the master batch and dissolved and/or dispersed, or directly added into the organic solvent upon dissolution or dispersion. It also may be fixed on the surface of the toner particles after the particles are obtained.

—External Additive—

Other inorganic particulates and polymer particulates may be used as external additives for improving flowability, developing ability and electrification property of the toner.

The primary particle diameter of the inorganic particulates is preferably in the range of from 5 nm to 2 μm and more preferably in the range of from 5 nm to 500 nm. It is preferable that the BET specific surface area of the inorganic particulates be in the range of from 20 m²/g to 500 m²/g.

The added amount of the inorganic particulates is preferably in the range of from 0.01% by mass to 5% by mass, and more preferably in the range of from 0.01% by mass to 2.0% by mass per the total mass of the toner particles.

The inorganic particulates are not particularly limited and can be appropriately selected in accordance with the purpose. Examples thereof include silica, alumina, titanium oxide, barium titanate, magnesium titanate, calcium titanate, strontium titanate, zinc oxide, tin oxide, quartz sand, clay, mica, sand-lime stone, diatom earth, chromium oxide, cerium oxide, colcothar, antimony trioxide, magnesium oxide, zirconium oxide, barium sulfate, barium carbonate, calcium carbonate, silicon carbide, and silicon nitride.

Examples of the polymer particulates include polystyrenes, methacrylic acid ester copolymers, acrylic acid ester copolymers and silicones obtained by soap-free emulsification polymerization, suspension polymerization or dispersion polymerization; products of polycondensation, including benzoguanamines and nylons; and polymerized particles of thermosetting resin.

When the surfaces of toner particles are treated with an external additive, the hydrophobicity of the surface is enhanced, and thereby it is possible to prevent reduction in the fluidity property and/or charge property of the toner even under high humidity environment. Examples of the surface treatment agents include silane coupling agents, silylation agents, silane coupling agents containing alkyl fluoride groups, organic titanate based coupling agents, aluminium based coupling agents, silicone oils and modified silicone oils.

—Cleaning Property Enhancer—

Examples of the cleaning property enhancer which is used for removing a developer remaining on a primarily transfer medium/photoconductor after a transferring step include fatty acid metal salts such as zinc stearates, calcium stearates and stearic acids; and polymer particulates obtained by soap-free emulsification polymerization, including polymethyl methacrylate particulates and polystyrene particulates.

It is preferred that the polymer particulates have a relatively narrow particle size distribution and volume average particle diameter of 0.01 μm to 1 μm.

(Production Method for Toner)

The production method of the toner of the present invention is not particularly limited, and can be appropriately selected according to the purpose, while the following production method is preferably used.

Of the production method of toner of the present invention, preferred production methods include (1) dissolving or dispersing a polyester resin and colorant in an organic solvent, and then granulating core particles by dispersing the dissolved or dispersed article in an aquatic medium, and (2) aggregating resin particulates and a colorant in an aquatic dispersed solution, the solution in which at least the resin particulates and colorant are dispersed, by heating, adding metal salt or adjusting pH thereof. In addition, another method in which resin particulates are deposited on the core particles by adding the core particles into an aquatic dispersed solution of the resin particulates containing modified-layered inorganic mineral is also preferable.

<Granulation of Core Particles by Dissolution/Dispersion of Polyester Resin>

It is preferred that a polyester resin, a colorant and an organic solvent which is for dissolving or dispersing a releasing agent each have a boiling temperature of 100° C. or lower and be volatile, for making desolventizing the solvent described below easier. Examples of the such organic solvents include toluenes, xylenes, benzenes, carbon tetrachloride, methylene chlorides, 1,2-dichloroethane, 1,1,2-trichloroethane, trichloroethylene, chloroforms, monochlorobenzene, dichloroethylidene, methyl acetates, ethyl acetates, methyl ethyl ketone and methyl isobutyl ketone. Those may be used alone or in combination. Of those, ester solvents such as methyl acetate and ethyl acetate; aromatic solvents such as toluene and xylene; and halogenated hydrocarbon such as methylene chloride, 1,2-dichloroethane, chloroform and carbon tetrachloride are preferable.

The polyester resin, colorant and releasing agent can be dissolved or dispersed at the same time, while they are usually dissolved or dispersed separately. Different organic solvents may be used when they are separately dissolved or dispersed, while it is preferred that only one solvent be used for making disposing of the solvent easier.

The concentration of the resin contained in the polyester resin dissolved/dispersed solution is preferably in the range of from 40% by mass to 80% by mass. When the concentration is excessively high, dissolving or dispersing the resin will be difficult. And further, the viscosity of the solution will increase, resulting in difficulty of handling the solution. And when the concentration is insufficient, the production volume of toner will decrease. When obtaining a mixture of the modified polyester resin having isocyanate groups at the terminals and the polyester resin, the resins may be dissolved or dispersed into a solution, while it is preferably obtained from already dissolved or dispersed solutions of the resins.

The colorant may be dispersed or dissolved alone or may be mixed into the polyester resin dissolved/dispersed solution. A dispersion auxiliary agent and/or polyester resin may be added in accordance with necessity. And the above-stated masterbatch may also be used.

When a wax is dissolved or dispersed into an organic solvent, in which the wax cannot be dissolved, as a releasing agent, a dispersed solution which can be obtained by a known method needs to be used. That is, it can be obtained by mixing an organic solvent and a wax and then dispersing the mixture using, for example, a dispersion machine such as a bead mill. In such process, dispersion time may be reduced by heating the mixture of the organic solvent and wax to the melting-point of the wax and cooling it down while stirring, before dispersing it with a dispersion machine. A wax may be used in combination with other waxes. It may also be used in combination with a dispersion auxiliary agent and/or polyester resin.

Water alone may be used or it may be used in combination with a water-solvable solvent as an aquatic medium The miscible solvents include alcohol (methanol, isopropanol, ethylene glycol), dimethylformamide, tetrahydrofuran, cellsolves (methyl cellsolve) and lower ketones (acetone, methyl ethyl ketone).

The used amount of the aquatic medium is preferably in the range of from 50 parts by mass to 2,000 parts by mass, and more preferably in the range of from 100 parts by mass to 1,000 parts by mass per 100 parts by mass of the toner composition. When it is less than 50 parts by mass, the dispersed state of the toner composition will be poor, and the toner particles having the desired particle diameters may not obtained. And when it is more than 2,000 parts by mass, the production cost of the toner will be impractical.

The dispersant or resin particulates are preferably dispersed into the aquatic medium before dispersing the dissolved- or dispersed-article of the toner composition into the aquatic medium. It enables to obtain a sharp particle size distribution and stabilized dispersion state.

The resin used for the resin particulates is not particularly limited, provided the resin is capable for forming a hydrophilic dispersion element. It can be selected from any resin of thermoplastic resins or thermosetting resins. Examples thereof include vinyl resins, polyurethane resins, epoxy resins, polyester resins, polyamide resins, polyimide resins, silicon resins, phenol resins, melamine resins, urea resins, aniline resins, ionomer resins and polycarbonate resins. These may be used alone or in combination. Among those, vinyl resins, polyurethane resins, epoxy resins polyester resins, and combination of these resins are preferable for obtaining the hydrophic dispersion element of spherical fine-resin particles.

—Method for Dispersing Resin Particulates into an Aquatic Medium—

The resin particulates can be obtained by polymerization by a known method appropriately selected in accordance with the purpose. It is preferably obtained as a hydrophilic dispersed solution of the resin particulates. The hydrophilic dispersed solution of the resin particulates can be prepared by, for example, one of the following processes (1) (when the vinyl resin is used) directly producing the hydrophilic dispersed solution by polymerizing a vinyl monomer by a means selected from suspension polymerization, emulsification polymerization, seed polymerization and the dispersion polymerization; (2) (when polymerized or condensed resins such as the polyester resins, polyurethane resins and epoxy resins are used) producing the hydrophilic dispersed solution by dispersing a precursor (such as a monomer and an oligomer) or a solution thereof into a water-based medium in the presence of an appropriate dispersant, and by heating the medium or giving a curing agent to thereby cure the resin; (3) (when polymerized or condensed resins such as the polyester resins, polyurethane resins and epoxy resins are used) dissolving an appropriate emulsifier into a precursor; (such as a monomer and an oligomer) or a solution thereof, and then conducting phase-inversion emulsification to the thus obtained solution after water is added thereto (4) pulverizing already prepared resin obtained by polymerization (which can be any one of addition polymerization, ring-opening polymerization, polyaddition, addition-condensation and condensation polymerization) using a pulverizer such as rotary type or jet type pulverizer, then classifying the pulverized particles to thereby obtain resin particulates, and dispersing the thus obtained resin particulates into water under the presence of an appropriate dispersant; (5) dissolving an already prepared resin obtained by polymerization (which can be any one of addition polymerization, ring-opening polymerization, polyaddition, addition-condensation and condensation polymerization) into a solvent to obtain a resin solution, and spraying the thus obtained resin solution to thereby obtain resin particulates, and then dispersing the thus obtained resin particulates into water under the presence of an appropriate dispersant; (6) dissolving an already prepared resin obtained by polymerization (which can be any one of addition polymerization, ring-opening polymerization, polyaddition, addition-condensation and condensation polymerization) into a solvent to obtain a resin solution, adding a poor solvent into the thus obtained resin solution or extracting resin particulates by cooling down the resin solution, desolventizing the solvent to obtain resin particles, and then dispersing the thus obtained resin particulates into water under the presence of an appropriate dispersant; (7) dissolving an already prepared resin obtained by polymerization (which can be any one of addition polymerization, ring-opening polymerization, polyaddition, addition-condensation and condensation polymerization) into a solvent to obtain a resin solution, dispersing the thus obtained resin solution into water under the presence of an appropriate dispersant, and then desolventizing the solvent by a means of, for example, heating or depressurization; and (8) dissolving an already prepared resin obtained by polymerization (which can be any one of addition polymerization, ring-opening polymerization, polyaddition, addition-condensation and condensation polymerization) into a solvent to obtain a resin solution, dissolving an appropriate emulsifier, and then conducting phase-inversion emulsification to the thus obtained resin solution after water is added thereto.

—Dispersant—

Surfactants, inorganic dispersants and/or polymer protective colloids may be used as a dispersant which is used for emulsion-dispersing a toner composition containing oil phase into an aquatic medium.

Examples of the surfactants include anion surfactants such as alkylbenzene sulfonate salts, -olefin sulfonate salts and phosphate salts; cation surfactants including amine salt surfactants (such as alkylamine salts, amino alcohol fatty acid derivatives, polyamine fatty acid derivatives and imidazoline) and quaternary ammonium salt surfactants (such as alkyltrimethyl ammonium salts, dialkyldimethyl ammonium salts, alkyldimethylbenzyl ammonium salts, pyridinium salts, alkyl isoquinolinium salts and benzethonium chlorides); nonionic surfactants such as fatty acid amide derivatives and polyvalent alcohol derivatives; and ampholytic surfactants such as alanine, dodecyldi(aminoethyl)glycine, di(octylaminoethyl)glycine and N-alkyl-N,N-dimethylammonium betaine.

By using the surfactant having fluoroalkyl groups, it is possible to obtain an increase in the effect of the surfactant with a significantly small amount thereof. Examples of the anionic surfactants which can preferably used and have fluoroalkyl groups include fluoroalkyl carboxylic acids having 2 to 10 carbon atoms and metal salts thereof, perfluorooctanesulfonyl disodium glutamate, 3-[omega-fluoroalkyl(C6 to C11)oxy]-1-alkyl(C3 to C4) sodium sulfonate, 3-[omega-fluoroalkanoyl(C6 to C8)-N-ethylamino]-1-propane sodium sulfonate, fluoroalkyl (C11 to C20) carboxylic acids and metal salts thereof perfluoroalkyl carboxylic acids (C7 to C13) and metal salts thereof, perfluoroalkyl (C4 to C12) sulfonic acids and metal salts thereof, perfluorooctane sulfonic acid diethanol amide, N-propyl-N-(2-hydroxyethyl)perfluoroactanesulfoneamide, perfluoroalkyl(C₆ to C₁₀)sulfoneamidepropyltrimethyl ammonium salts, perfluoroalkyl(C6 to C10)-N-ethylsulfonyl glycine salts and monoperfluoroalkyl(C6 to C16)ethyl phosphate esters. Examples of the cation surfactants include aliphatic primary, secondary or tertiary amine acids, aliphatic quaternary ammonium salts such as perfluoroalkyl(C₆ to C₁₀)sulfonamide propyltrimethyl ammonium salts, aliphatic benzalkonium salts, benzethonium chloride, pyridinium salts and imidazolium salts.

Examples of the inorganic dispersants include tricalcium phosphate, calcium carbonate, titanium oxide, colloidal silica and hydroxyapatite.

Examples of the polymeric protective colloids include (meta)acrylic monomers having acids and hydroxyl groups; alcohols or ethers of vinyl alcohols; esters of compounds having vinyl alcohol and carboxyl groups; amide compounds and methylol compounds thereof, chlorides; homopolymer and copolymers of nitrogen atoms or those having heterocyclic rings of nitrogen atoms; polyoxyethylenes; and celluloses.

Examples of the above-stated acides include acrylic acids, methacrylic acids, α-cyanoacrylic acids, α-cyanomethacrylic acids, itaconic acids, crotonic acids, fumaric acids, maleic acids and maleic acid anhydrides. Examples of the above-stated (meth)acryl monomers having the hydroxyl groups include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate ester, diethylene glycol monomethacrylate ester, glycerine monoacrylate ester, glycerine monomethacrylate ester, N-methylolacrylamide and N-methylolmethacrylamide. Examples of the vinyl alcohols and the ethers of vinyl alcohols include vinylmethylether, vinylethylether and vinylpropylether. Examples of the ethers of the compounds containing vinyl alcohol and carboxyl groups include vinyl acetate, vinyl propionate and vinyl butyrate. Examples of the amide compounds and methylol compounds thereof include acrylamides, methacrylamides, diacetone acrylamide acids, and methylol compounds thereof. Examples of the chlorides include chloride acrylates and chloride methacrylate. Examples of the homopolymer and copolymers of nitrogen atoms or of those having heterocyclic rings of nitrogen atoms include vinyl pyridine, vinyl pyrrolidone, vinyl imidazole and ethyleneimme. Examples of the polyoxyethylenes include polyoxyethylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearic acid phenyl and polyoxyethylene pelargonic acid phenyl. Examples of the celluloses include methylcellulose, hydroxyethylcellulose and hydroxypropylcellulose.

A dispersion stabilizer can be used in the preparation of the dispersed solution in accordance with necessity.

Examples of the dispersion stabilizer include those such as calcium phosphate which can be soluble in acid and/or alkali.

When the dispersion stabilizer is used, calcium phosphate salt can be removed from particulates by dissolving the calcium phosphate salt in acid such as hydrochloric acid and by a means of, for example, washing with water or decomposition with oxygen.

A catalyst capable of the above-stated elongation reaction/cross-linking reaction may be used in the preparation of the dispersed solution. Examples of the catalyst include dibutyl tin laurate and dioctyl tin laurate.

When the dispersant is used, it may be left on the surface of a toner particle, while it is preferred that it be removed for obtaining better chargeability.

The method for conducting above-stated dispersion is not particularly limited, and publicly known equipments from various types/ways such as a low speed shearing way, a high speed shearing way, a friction way, a high pressure jet way and an ultrasonic way can be applied. The high-speed shearing way is preferred in order to obtain dispersion element having particle diameters of 2 μm to 20 μm. The number of rotations in the high-speed shearing way is not particularly limited, while it is preferably in the range of 1,000 rpm to 30,000 rpm and more preferably in the range of 5,000 rpm to 20,000 rpm. The temperature upon dispersion is preferably in the range of 0° C. to 150° C. (pressurized) and more preferably 20° C. to 80° C.

—Desolventizing—

A known method can be used for desolventizing the organic solvent in the obtained emulsion dispersant components. For example, desolventation can be done by increasing temperature of the whole solution in which the solvent is included to thereby vaporize the organic solvent.

—Elongation Reaction and/or Cross-Linking Reaction—

When adding a modified polyester resin having isocyanate groups at its terminal and amines reacting with the resin in order to introduce modified polyester resin having urethane and/or urea groups, the amines may be mixed in an oil phase before dispersing toner composition into the aquatic medium, or amines may be added to the aquatic medium. Time need for the reaction is determined based on the isocyanate group structure of the polyester prepolymer and the reactivity of the added amines, while it is preferably in the range of 1 minute to 40 hours and more preferably 1 hour to 24 hours. The reaction temperature is preferably in the range of 0° C. to 150° C. and more preferably 20° C. to 98° C. The reaction process may be done during thermally fixing the resin particulates after the resin particulates which contain the modified-layered inorganic mineral for the shell are deposited and/or aggregated on the core.

<Granulation of Core Particle by Aggregating Resin Particulate>

As described above, the resin particulates for the core can be granulated by dissolving the resin particulates into an organic solvent and dispersing the resulted solvent into an aquatic medium. Furthermore, when a vinyl copolymerized resin is used, a resin particulate-containing dispersed solution can be easily obtained by, for example, emulsion polymerization.

It is preferred that colorant powder be directly dispersed into an aquatic medium when aggregating the resin particulates in the aquatic medium. In such case, a dispersant such as surfactant may be used. A bead mill is preferably used for uniformly dispersing the colorant. And when a releasing agent is used, a wax is preferably dispersed into the aquatic medium. Also in such case, the bead mill is preferably used. As another method, a releasing agent may be used when polymerizing resin. That is, add and disperse a polymerizable monomer into an already prepared releasing agent-dispersed dispersed solution, and then add a polymerization initiator to start polymerization. During such polymerization, resin particulates for the core may be preliminarily obtained by, for example, emulsion polymerization, and into which, the releasing agent-dispersed dispersed solution and polymerizable monomer may be added. After the polymerization, further polymerization may be done with adding further polymerizable monomer. By doing so, the releasing agent can be more firmly taken into the resin particulates.

—Aggregation—

The core particles are obtained by mixing and aggregating the resin particulate-dispersed solution and colorant-dispersed solution. In accordance with necessity, dispersed solutions such as the releasing agent may also be mixed and aggregated. During this process, it is preferred that the colorant be aggregated particularly uniformly. In order to obtain desired aggregated state, a means such as heating, adding a metal salt or adjusting pH can preferably be used. One resin particulate-dispersed solution can be used alone, or two or more resin particulate-dispersed solutions can be used in combination. The resin particulate-dispersed solution(s) can be added at a time or several times. The same is true in the case of the colorant-dispersed solution. The metal salt is not particularly limited, and can be selected in accordance with the purpose. Examples thereof include sodium and kalium as monovalent metals and calcium and magnesium as divalent metals. Examples of trivalent metals include aluminum. Examples of an anion of such salts include chloride ions, bromide ions, iodide ions, carbonate ions and sulfate ions. Among above-stated salts, magnesia chlorides, aluminum chlorides, and complexes and multimeric complexes of such chlorides are preferable. Heating the mixture during/after the aggregation can promote mutual fusions of resin particulates, and thus, is preferable for obtaining desired uniformity in the toner. Buy giving further heat, the shape of the toner particles can be controlled. In general, when more heat is given, the toner particles will be more spherical. This heating process may be done during thermally fixing the resin particulates after the resin particulates which contain the modified-layered inorganic mineral for the shell are deposited and/or aggregated on the core.

<Shell Formed on Core Particle>

—Depositing/Aggregating and Thermally Fixing Resin Particulates Containing Modified-Layered Inorganic Mineral—

It is preferred to use a method similar to the above-stated aggregating method to deposit and/or aggregate the resin particulates containing the modified-layered inorganic mineral on the core particles. The core particles can be obtained by method such as the above-stated two methods. In the method for depositing and/or aggregating the resin particulates, dispersed solution of the resin particulates containing the layered inorganic mineral is added into dispersed solution containing the core particles. That is, the method includes mixing the solutions, and then, heating the solution, adding metal salt or adjusting pH thereof. Heating the solution after the deposition and/or aggregation are almost completed is preferable for thermally fixing the resin particulates.

Higher temperature at the thermal fixation can reduce the time need for thermal fixation, while mutual aggregation of the particles should preferably be avoided. Means to avoid the mutual aggregation can be appropriately selected from, for example, adjusting heating temperature, adding surfactant and adjusting particle concentration by adding an aquatic medium.

—Cleaning and Drying—

Known techniques can be used for cleaning and drying toner particles dispersed in the aquatic medium.

For example, toner powder can be obtained by the following methods: removing impurities and surfactants by repeating the following process several times, including performing solid-liquid separation using, for example, centrifugal separator or filter press, re-dispersing the thus obtained toner cake into ion-exchanged water having a temperature in the range of room temperature to about 40° C., and adjusting the pH using acids or alkali upon necessity, and then, drying using, for example, a pneumatic conveying dryer, a circulation dryer, a vacuum dryer or a vibro-fluidized dryer. During the process, particulate components may be removed from the toner using, for example, centrifugal separator. And after dried, the toner particles may be sieved using a known classifier to obtain particles having a desired particle diameter distribution.

—External Additive-Treatment—

By giving a mechanical impact to the mixed powder of the thus obtained dried toner powder and other particles such as the charge controllability fine particles and fluidizer particulates, the other particles are fixed and fused to the surface of the toner particles, preventing the other particles from being detached therefrom. Specific examples of the method for applying mechanical impact includes, for example, applying an impact to the mixture using high-speed rotating blades; and providing the mixture in a high speed gas flow to accelerate the particles of the mixture so that the particles crash one another or particles in a complexed form crash to a provided appropriate crash plate. An apparatus used for this method can be selected from, for example, Ang Mill (manufactured by Hosokawa Micron Ltd.); an apparatus based on I type mill (manufactured by Nippon Pneumatic MFG. Co., Ltd.), which has a lowered pulverization air pressure; a hybridization system (manufactured by Nara Machinery Co., Ltd.); a cryptron system (manufactured by Kawasaki Heavy Industries, Ltd.); and an automatic mortar.

—Shape and Size of Toner Particle—

The shape and size of the toner particles are not particularly limited, and can be adjusted at an appropriate shape/size in accordance with the purpose, while the toner particles preferably have the average circularity, volume average particle diameter and the ratio of the volume average particle diameter to the number average particle diameter (volume average particle diameter/number average particle diameter) described below.

The shape of the toner particles may be altered by, for example, a known grinding process: while the more spherical the shape of the particles is, the more preferable the toner is. The toner particles having spherical shapes can suppress of problems such as occurrences of image dust as they have excellent particle transferability, and thus the toner is advantageous in improving overall image quality including image reproductivity.

The average circularity of the toner is preferably 0.96 or more, more preferably 0.965 or more, and further preferably 0.97 or more.

The average circularity can be measured with, for example, FPIA-2100 (a flow type particle image analyzer manufactured by Sysmex) with analysis software, FPIA-2100 Data Processing Program for FPIA version 00-10.

The volume average particle diameter of the toner particles is not particularly limited, and can be an appropriate value according to the purpose, while it is preferably in the range of 2 μm to 10 μm and more preferably in the range of 3 μm to 8 μm.

The ratio of the volume average particle diameter to the number average particle diameter of the toner particles is preferably in the range of from 1.00 to 1.20, and more preferably in the range of from 1.00 to 1.15.

The volume average particle diameter and the ratio of the ratio of the volume average particle diameter to the number average particle diameter of the toner can be measured with, for example, Multisizer III (a coulter counter manufactured by Beckman Coulter, Inc.) at an aperture of 100 μm and Beckman Coulter Multisizer 3 Version 3.51 (analysis software from Beckman Coulter, Inc.).

(Developer)

The developer of the present invention contains at least the toner of the present invention and further contains other selected appropriate components such as a carrier. The developer contained in the developing device is a developer containing a toner, and the developer may be a one-component developer or a two-component developer.

The developer of the present invention can be preferably used in various known electrophotography developments such as magnetic one-component development, non magnetic one-component development and two-component development. In particular, the developer of the present invention can be suitably used with the toner container, process cartridge, image forming apparatus and image forming method of the present invention as described below.

(Toner Container)

The toner container of the present invention contains the toner and/or the developer of the present invention.

The toner container is not particularly limited and may be appropriately selected from known toner containers in accordance with the purpose. Preferred examples thereof include those equipped with a lid.

The size, configuration, structure and material of the toner container are not particularly limited and can be appropriate values in accordance with the purpose. For example, the shape of the toner container is preferably selected from cylindrical toner containers, and particularly, it is preferred to use cylindrical toner containers having spiral groove at its inner periphery so that is configured to rotate to convey contained toner particles to an outlet, and in which a part of or the entire toner container is configured as a bellows.

The material of the toner container is not particularly limited and can be selected from appropriate materials. It is preferably selected from materials that enable to achieve high accuracy, including polyester resins, polyethylene resins, polypropylene resins, polystyrene resins, polyvinyl chlorides, polyacrylic resins, polycarbonate resins, ABS resin and polyacetal resins.

The toner container of the present invention can be easily stored and transported, is excellent in handling property, and can be preferably used when it is detachably attached to, for example, the process cartridge or the image forming apparatus to supply toner.

(Image Forming Apparatus)

The image forming apparatus of the invention at least contains a latent electrostatic image bearing member, latent electrostatic image forming unit, developing unit, transfer unit and fixing unit. And it further contains other suitable units such as a charge eliminating unit, cleaning unit, recycling unit and control unit in accordance with necessity.

The image forming method of the present invention at least includes a latent electrostatic image forming step, a developing step, a transferring step and a fixing step. And it further includes other suitable steps such as a charge eliminating step, a cleaning step, a recycling step and a controlling step in accordance with necessity.

The latent electrostatic image forming step is for forming a latent electrostatic image on the latent electrostatic image bearing member.

The material, shape, configuration and size of the latent electrostatic image bearing member (which may be hereinafter called an electrophotographic photoconductor, photoconductor or image bearing member) are not particularity limited and can be appropriately selected form known materials, shapes, etc. Preferred shape thereof is a drum shape, and preferred material thereof is one selected from inorganic photoreceptors such as amorphous silicon and selenium and organic photoreceptors such as polysilane and phthalopolymethine. Among those, the amorphous silicon is preferred because of its longer operating life.

The latent electrostatic image may be formed, for example, by uniformly charging the surface of the photoconductor and irradiating the surface imagewise. These processes are performed with the latent electrostatic image forming unit. The latent electrostatic image forming unit contains, for example, a charger which uniformly charges the surface of the photoconductor, and an irradiator which exposes the surface of the latent image bearing member imagewise.

Charging may be performed by, for example, applying voltage to the surface of the latent electrostatic image bearing member using the charger.

The charger is not particularly limited, and can be appropriately selected according to the purpose. Examples thereof include known contact chargers equipped with a conductive or semi-conductive roll, brush, film and rubber blade; and non-contact chargers utilizing corona discharging such as corotron and scorotron discharges.

Exposure can be performed by, for example, exposing the surface of the latent electrostatic image bearing member imagewise using the exposer.

The exposure is not particularly limited and can be appropriately selected, provided it is capable of imagewisely exposing the surface of the latent electrostatic image bearing member. Examples thereof include photographic optical systems, rod lens array systems, laser optical systems and liquid crystal shutter optical systems.

In the invention, a backlight system may be used as a means to imagewisely expose the latent electrostatic image bearing member from the inside thereof

—Developing Step and Developing Unit—

The developing step is for developing the latent electrostatic image with the toner or the developer of the invention to thereby form a visible image.

The visible image can be formed by, for example, developing the latent electrostatic image using the toner or the developer of the present invention. This process can be performed with the developing unit.

The developing unit is not particularly limited and can be appropriately selected in accordance with the purpose, provided it is capable of developing the latent electrostatic image using the toner or the developer of the present invention. Examples of such developing unit include those at least having an image developing apparatus that contains the toner or the developer and can supply the toner or the developer to the surface of the image bearing member with contacting or without contacting thereto. It is more preferred that the toner container be also contained in the image developing apparatus.

The image developing apparatus may be a dry developing system or a wet developing system. And also, it may be for single color only or for multiple colors. Preferred examples of the image developing apparatus include those having a mixer for friction-churning the toner or the developer to thereby charge the particles thereof and a rotatable magnet roller.

In the development apparatus, a magnetic brush can be formed by, for example, mixing and churning the toner with the carrier to generate friction between the particles thereof. The friction then charges the particles, and then the charged toner particles stand on the surface of the rotating magnet roller, forming the magnetic brush. Since the magnet roller is located near the latent electrostatic image bearing member (or photoconductor), a part of the toner particles forming the magnetic brush moves to the surface of the latent electrostatic image bearing member (photoconductor) attracted by electrical force. Thus, the latent electrostatic image is developed with the toner, and the visible toner image is formed on the surface of the latent electrostatic image bearing member (photoconductor).

The developer contained in the development apparatus contains the toner of the present invention. It may be a one-component or two-component developer. The toner contained in the developer is the toner of the invention.

—Transferring Step and Transferring Unit—

The transferring step is for transferring the visible image onto a recording medium. In a preferred embodiment, the visible image is transferred onto an intermediate transferring member in primary transferring, and then the visible image is transferred from the intermediate transferring member to the recording medium in secondary transferring. It is more preferred that toners of two or more colors are provided, and further preferably toners of full colors are provided. In such case, visible images of each color are transferred onto the intermediate transferring member, forming a complex-transferred image, in primary transferring, and then the complex-transferred image is transferred onto the recording medium in secondary transferring.

The visible image can be transferred by, for example, a means of charging the latent electrostatic image bearing member (or photoconductor) using a transferring charger. This process can be performed with the transfer unit. In a preferred embodiment, the transferring unit contains a primary transferring unit for transferring the visible image onto the intermediate transferring member to form the complex-transferred image, and a secondary transferring unit for transferring the complex-transferred image onto the recording medium.

The intermediate transferring member is not particularly limited and can be appropriately selected from known transferring members according to the purpose. Preferred examples thereof include transferring belts.

It is preferred that the primary and the secondly transfer units each contain at least an image transferer that transfers the visible image formed on the latent electrostatic image bearing member (or photoconductor) onto the recording medium by applying a peeling charge to the latent electrostatic image bearing member. One transfer unit can be used alone, or two or more transfer units can be used in combination.

Examples of the image-transfer unit include corona transfer units which use corona discharging; transfer belts; transfer rollers; pressure transfer rollers; and adhesion transfer units.

The recording medium is not particularly limited can be appropriately selected from known recording media/recording paper.

The fixing step is for fixing the visible image transferred onto the recording medium. The visible image is fixed using a fixing unit. The fixing step can be performed for every transferred visible image of each color on the recording medium, or at a time after the transferred visible images of all colors have been provided on the recording medium.

The fixing unit is not particularly limited and can be appropriately selected depending on the intended use, while those using a known heat-pressurizing means are preferable. Examples of the heat-pressurizing means include combinations of a heat roller and a pressure roller and combinations of a heat roller, a pressure roller and an endless belt.

The heating temperature at the heat pressurizing means is preferably in the range of 80° C. to 200° C.

In the present invention, for example, a known optical fixing unit may be used instead of or in combination with the fixing step and the fixing unit, in accordance with the purpose.

The charge-eliminating step is for discharging the surface of the latent electrostatic image bearing member by applying a discharge bias thereto. The charge eliminating step can be preferably performed with the charge eliminating unit.

The charge elimination unit is not particularly limited, provided it can apply the discharge bias to the latent electrostatic image bearing member. It can be selected from known charge eliminators, and preferred examples thereof include charge elimination lamps.

The cleaning step is for removing residual particles of the toner, which remain on the latent electrostatic image bearing member. The cleaning step can be preferably performed with the cleaning unit.

The cleaning unit is not particularly limited, provided it can remove the residual particles from the latent electrostatic image bearing member. The cleaning unit can be selected from known cleaners such as magnetic brush cleaners, electrostatic brush cleaners, magnetic roller cleaners, blade cleaners, brush cleaners and web cleaners.

The recycling step is for reusing the removed toner particles in the above-stated developing unit. The recycling step can be preferably performed with the recycling unit.

The recycling unit is not particularly limited, and can be selected from known transport units.

The controlling step is for controlling the above-stated steps. It can be preferably performed with the control unit.

The control unit is not particularly limited and can be appropriately selected according to the purpose, provided it can control the movements of the above-stated units. It can be selected from, for example, sequencers and computers.

(Process Cartridge)

The process cartridge of the present invention at least contains the latent electrostatic image bearing member and the developing unit which is configured to develop the latent electrostatic image formed on the latent electrostatic image bearing member using the toner to thereby form the visible image. The process cartridge further contains at least one selected from the charging unit, the cleaning unit and the charge-elimination unit.

The developing unit at least contains a developer container of the present invention and a developer bearing member which is for bearing and conveying the developer. In accordance with the necessity, it may further contain a layer thickness controlling member for adjusting the thickness of a toner layer provided on the developer bearing member.

The process cartridge of the present invention can be detachably attached to various image forming apparatuses for electrophotographic, and is preferably detachably attached to the below-mentioned image forming apparatus of the present invention.

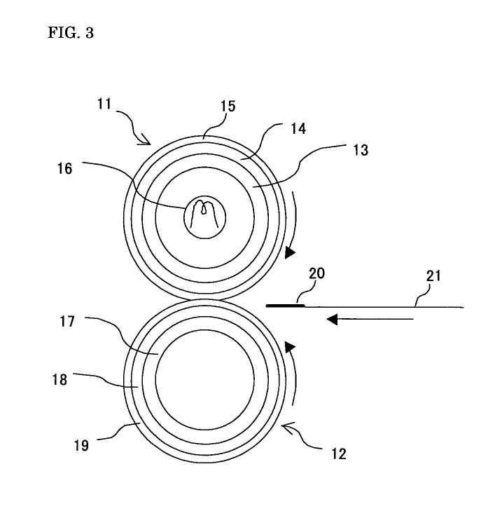

FIG. 2 is a schematic view showing an example of the image forming apparatus equipped with the process cartridge 10 of the present invention. The image forming apparatus contains a latent electrostatic image bearing member (or photoconductor) 13. It further contains a charging unit 11, a developing unit 14 and a cleaning unit 12 which are located around the photoconductor 13.

The operation of the image forming apparatus 2 shown in FIG. 2 will be explained hereafter. The photoconductor 13 rotates at a predetermined speed. The surface of the rotating photoconductor 13 is uniformly electrified with a predetermined positive or negative potential released from the charging unit 11. Then, an image exposing unit (not shown) such as a slit exposure or a laser beam scanning exposure exposes the surface of the photoconductor 13 to an image exposing light emitted from the image exposing unit, sequentially forming a latent electric field image on the photoconductor 13. The formed latent electric field image is developed with toner by the developing unit 14, and then, the developed image, or toner image, is transferred on a transfer material (not shown) by a transfer unit (not shown). The transfer material is supplied in between the photoconductor 13 and the transfer unit from a feeding member (not shown), and moved forward accordingly to the rotation of the photoconductor 13. The transfer material on which the toner image is transferred is separated from the surface of the photoconductor 13 and feed to a fixing unit (not shown). The toner image is then fixed at the fixing unit, and then, the transfer material is discharged from the process cartridge as a photocopy or printed material. Toner particles remaining on the surface of the photoconductor 13 after the toner image is transferred therefrom are removed with the cleaning unit 12. Then, the electricity on the surface is removed to be ready for another image forming.

According to the present invention, by having a layered inorganic mineral in which at least a part of interlayer ions is modified with organic ions exist in particles of a toner, sufficient electrostatic chargeability and excellent durability of the toner can be obtained. The effects will be further magnified when resin particulates containing the layered inorganic mineral are contained in the particles. It is considered that the magnified effects are obtained because containing the resin particulates allows the particles to have the layered inorganic mineral in the outer area and allows the inorganic mineral to be dispersed more uniformly. In addition, it is also considered that a higher dispersibility of the layered inorganic mineral can be achieved when resin particulates in which the layered inorganic mineral is more uniformly dispersed are contained. And further, the structure of the toner particle which is made of a core particle and a shell provided on the core and containing the resin particulates allows more effectively locating the layered inorganic mineral in the outer area of the toner particle, and also allows to reduce the used amount of the layered inorganic mineral. And because the resin particulates are thermally fixed after they are provided or aggregated on the core particle, the layered inorganic mineral is unlikely to be released and contaminate other members.

### EXAMPLES

Hereinafter, with referring to Examples and Comparative Examples, the invention is explained in detail and the following Examples and Comparative Examples should not be construed as limiting the scope of this invention.

In the following Synthesis Examples, Examples and Comparative Examples, the characteristics of polyester resin, vinyl copolymer resin and toner are measured as described below. It should be noted that although the toner of the present invention is evaluated in Examples as it is used in a one-component developer, the toner of the present invention can also be used in two-component developers when combined with a suitable external additive-treatment and a appropriately selected carrier.

<Volume Average Particle Diameter and Particle Size Distribution of Toner>

For measuring the particle size distribution of toner particles, Coulter counter method including Coulter Counter TA-II and Coulter Multisizer II (both manufactured by Beckman Coulter, Inc.) was used. The measurement method will be described below.

First, 0.1 mL to 5 mL of a surfactant was added as a dispersant (alkylbenzene sulfonate salt) to 100 mL to 150 mL of an electrolytic water solution. Here, the electrolytic water solution containing 1% by mass of NaCl was prepared using 1st grade sodium chloride. For this preparation, ISOTON-II (manufactured by Beckman Coulter, Inc.) was used. Then, 2 mg to 20 mg of a solidified sample to be measured was added. The sample was then dispersed into the electrolytic water solution using an ultrasonic dispersing machine for about 1 to 3. Using the above-stated measurement device with a 100 μm aperture, the volume and the number of the toner particles were obtained. Based on the obtained results, the volume distribution and the number distribution were calculated. From the thus obtained distributions, the volume average particle diameter (Dv) and the number average particle diameter (Dp) were obtained.

The channels were 13 channels of 2.00 μm to less than 2.52 μm; 2.52 μm to less than 3.17 μm; 3.17 μm to less than 4.00 μm; 4.00 μm to less than 5.04 μm; 5.04 μm to less than 6.35 μm; 6.35 μm to less than 8.00 μm; 8.00 μm to less than 10.08 μm; 10.08 μm to less than 12.70 μm; 12.70 μm to less than 16.00 μm; 16.00 μm to less than 20.20 μm; 20.20 μm to less than 25.40 μm; 25.40 μm to less than 32.00 μm; and 32.00 μm to less than 40.30 μm are used, or that is to say, the particles having the particle diameter of 2.00 μm to less than 40.30 μm can be measured.

<Average Circularity of Toner Particle>

A method of using optical detection band, in which suspension liquid containing particles is passed through the imaging portion detection band on a flat plate and then the particle image is optically detected by using CCD camera to be analysed, was used as a measurement method of the shape of the toner particles. The average degree of circularity was obtained by dividing the boundary length of a correspondent circle having an area equal to a projected area of a particle, which can be measured from the above-stated method, by the real boundary length of the particle.

The average circularity was measured with FPIA-2000, a Flow Particle Image Analyzer. More specifically, 0.1 mL to 0.5 mL of a surfactant (alkylbenzene sulfonate salt) was added as a dispersant into 100 mL to 150 mL of toner container-contained water from which impurities have been previously removed. And further, 0.1 g to 0.5 g of a sample was added thereto. The surfactant and sample was dispersed into the thus obtained suspension liquid using the ultrasonic dispersing machine for about 1 to 3 minutes. The resulted dispersed solution had a concentration of particles in the range of 3,000/L to 10,000/L, and then the shape and the distribution of the toner were measured using the above-stated apparatus.

<Mass Average Molecular Weight>

The molecular weights of the polyester resin, the vinyl copolymer resin and other resins were obtained by gel permeation chromatography, or GPC, under the following conditions.

Apparatus: HLC-8220 GPC (manufactured by Tosoh Corporation)

Column: TS Kgel Super HZM-Mx3

Temperature: 40° C.

Solvent: tetrahydrofuran, or THF

Flow rate: 0.35 ml/min.

Sample: 0.01 ml of sample having a concentration of 0.05% by mass to 0.6% by mass was poured.

Based on molecular weight-calibration curves obtained from monodisperse polystyrene standard samples and the molecular weight distribution of the toner resin, measured under the above-stated conditions, the mass average molecular weight was obtained. As the monodisperse polystyrene standard samples, those having a size of 5.8×100; 1.085×10,000; 5.95×10,000; 3.2×100,000; 2.56×1,000,000; 2.93×1,000; 2.85×10,000; 1.48×100,000; 8.417×100,000; and 7.5×1,000,000 were used.

<Glass Transition Temperature>

The glass transition temperatures of the polyester resin, the vinyl copolymer resin and other resins were measured with DSC-6220R (a differential scanning calorimeter manufactured by Seiko Instruments Inc.). Specifically, the samples were heated from room temperature to 150° C. at temperature increasing rate of 10° C./min. The samples were kept under 150° C. for 10 minutes, cooled down to room temperature, and kept under room temperature for 10 minutes. The samples were again heated to 150° C. at temperature increasing rate of 10° C./min. Then, the glass transition temperature was obtained from the baseline under the glass transition temperature and at one-half of the baseline curve over the glass transition temperature.

<Particulate Diameter>

The diameters of the resin particulates of the vinyl copolymer resin and other resins were obtained using LA-920 (a particle size distribution measurement device, manufactured by HORIBA, Ltd.). The particulates were monodispersed when measured.

### Synthesis Example 1

—Synthesization of Polyester Resin P-1—

Into a reaction container equipped with a cooling tube, a stirrer and a nitrogen introducing tube, 553 parts by mass of ethylene oxide (2 mol) adduct of bisphenol A, 196 parts by mass of propylene oxide (2 mol) adduct of bisphenol A, 220 parts by mass of terephthalic acid, 45 parts by mass of adipic acid and 2 parts by mass of dibutyl tin oxide were placed. They were reacted under an atmospheric pressure at 230° C. for 8 hours, and further reacted under a reduced pressure in the range of 10 mmHg to 15 mmHg at 230° C. for 5 hours. Then, 26 parts by mass of trimellitic anhydride was added into the reacted product, and the resulted mixture was further reacted under an atmospheric pressure at 180° C. for 2 hours. Thereby polyester resin (P-1) was obtained.

The thus obtained polyester resin (P-1) had a number average molecular weight of 2,200, a weight average molecular weight of 5,600, a glass transition temperature (Tg) of 43° C. and an acid value of 24 mg KOH/g.

### Synthesis Example 2

—Synthesization of Polyester Resin P-2—

Into the reaction container equipped with the cooling tube, the stirrer and the nitrogen introducing tube, 229 parts of ethylene oxide (2 mol) adduct of bisphenol A, 529 parts by mass of propylene oxide (3 mol) adduct of bisphenol A, 208 parts by mass of terephthalic acid, 46 parts by mass of adipic acid and 2 parts by mass of dibutyl tin oxide were placed. They were reacted under an atmospheric pressure at 230° C. for 8 hours, and further reacted under a reduced pressure in the range of 10 mmHg to 15 mmHg at 230° C. for 5 hours. Then, 44 parts by mass of trimellitic anhydride was added into the reacted product, and the resulted mixture was further reacted under an atmospheric pressure at 180° C. for 2 hours. Thereby polyester resin (P-2) was obtained.

The thus obtained polyester resin (P-2) had a number average molecular weight of 2,500, a weight average molecular weight of 6,700, a glass transition temperature (Tg) of 43° C. and an acid value of 25 mg KOH/g.

### Synthesis Examples 3 to 4

<Synthesization of Resin Particulates (V-1 and V-2) of Vinyl Copolymer which Contain Modified-Layered Inorganic Mineral>

—Resin Particulate (V-1) of Vinyl Copolymer—

Into the reaction container equipped with the cooling tube, the stirrer and the nitrogen introducing tube, 1.6 parts of dodecyl sodium sulfate and 502 parts of ion-exchanged water were placed. They were heated to 80° C., and then solution of 100 parts by mass of ion-exchanged water and 2.5 parts by mass of potassium peroxodisulfate which was dissolved into that ion-exchanged water was added. After 15 minutes the solution had been added, a solution dispersed using CLEARMIX (manufactured by M-Technique Co.) for 60 minutes was delivered by drops into the reaction container in 90 minutes. The dispersed solution was composed of 152 parts by mass of styrene monomer, 38 parts by mass of butyl acrylate, 10 parts by mass of methacrylic acid, 3.5 parts by mass of n-octylmercaptan and 4 parts by mass of layered inorganic mineral, montmorillonite (Clayton APA, manufactured by Southern Clay Products) in which at least a part thereof is modified with quaternary ammonium salt having benzyl groups. After all the dispersed solution was added, the resulted mixture was kept at 80° C. for 60 minutes. Then, it was cooled down, and thereby dispersed solution of the resin particulates (v-1) of vinyl copolymer was obtained. The concentration of the solid content in the dispersed solution was 25% by mass. The average particle diameter of the particulates was 70 nm. A small amount of the dispersed solution was taken and placed on a petri dish, and then the dispersion media contained therein was evaporated to obtain solid tetrahydrofuran. The obtained solid tetrahydrofuran had a number average molecular weight of 11,000, mass average molecular weight of 18,000 and glass transition temperature (Tg) of 65° C.

—Resin Particulate (V-2) of Vinyl Copolymer—

Into the reaction container equipped with the cooling tube, the stirrer and the nitrogen introducing tube, 1.6 parts of dodecyl sodium sulfate and 502 parts of ion-exchanged water were placed. They were heated to 80° C., and then solution of 100 parts by mass of ion-exchanged water and 2.5 parts by mass of potassium peroxodisulfate which was dissolved into that ion-exchanged water was added. After 15 minutes the solution had been added, a solution dispersed using CLEAR/X (manufactured by M-Technique Co.) for 60 minutes was delivered by drops into the reaction container in 90 minutes. The dispersed solution was composed of 152 parts by mass of styrene monomer, 38 parts by mass of butyl acrylate, 10 parts by mass of methacrylic acid, 3.5 parts by mass of n-octylmercaptan and 8 parts by mass of layered inorganic mineral, montmorillonite (Clayton APA, manufactured by Southern Clay Products) which was obtained by modifying at least a part of Clayton APA with ammonium salt having polyoxy ethylene groups. After all the dispersed solution was added, the resulted mixture was kept at 60° C. for 80 minutes. Then, it was cooled down, and thereby dispersed solution of the resin particulates (v-2) of vinyl copolymer was obtained. The concentration of the solid content in the dispersed solution was 25% by mass. The average particle diameter of the particulates was 70 nm. A small amount of the dispersed solution was taken and placed on a petri dish, and then the dispersion media contained therein was evaporated to obtain solid tetrahydrofuran. The obtained solid tetrahydrofuran had a number average molecular weight of 11,500, mass average molecular weight of 18,200 and glass transition temperature (Tg) of 65° C.

### Synthesis Examples 5 to 6

<Synthesization of Resin Particulates (V-3 and V-4) of Vinyl Copolymer Not Containing Modified-Layered Inorganic Mineral>

—Resin Particulate (V-3) of Vinyl Copolymer—

Into the reaction container equipped with the cooling tube, the stirrer and the nitrogen introducing tube, 1.6 parts of dodecyl sodium sulfate and 492 parts of ion-exchanged water were placed. They were heated to 80° C., and then solution of 100 parts by mass of ion-exchanged water and 2.5 parts by mass of potassium peroxodisulfate which was dissolved into that ion-exchanged water was added. After 15 minutes the solution had been added, a mixed solution composed of 152 parts by mass of styrene monomer, 38 parts by mass of butyl acrylate, 10 parts by mass of methacrylic acid and 3.5 parts by mass of n-octylmercaptan was delivered by drops into the reaction container in 90 minutes. After all the dispersed solution was added, the resulted mixture was kept at 80° C. for 60 minutes. Then, it was cooled down, and thereby dispersed solution of the resin particulates (v-3) of vinyl copolymer was obtained. The concentration of the solid content in the dispersed solution was 25% by mass. The average particle diameter of the particulates was 50 nm. A small amount of the dispersed solution was taken and placed on a petri dish, and then the dispersion media contained therein was evaporated to obtain a solidified product. The obtained solidified product had a number average molecular weight of 11,000, mass average molecular weight of 18,000 and glass transition temperature (Tg) of 65° C.

—Resin Particulate (V-4) of Vinyl Copolymer—

Into the reaction container equipped with the cooling tube, the stirrer and the nitrogen introducing tube, 800 parts of dispersed solution of the resin particulates (V-3) of vinyl copolymer, 0.5 parts of dodecyl sodium sulfate and 750 parts of ion-exchanged water were placed. While they were heated at 80° C., solution composed of 50 parts by mass of ion-exchanged water and 1.2 parts by mass of potassium peroxodisulfate which was dissolved into that ion-exchanged water was added. After 15 minutes the solution was added, a mixed solution was delivered by drops into the reaction container in 90 minutes. The mixed solution was composed of 76 parts by mass of styrene monomer, 19 parts by mass of butyl acrylate, 5 parts by mass of methacrylic acid, 1.5 parts by mass of n-octylmercaptan and 30 parts by mass of paraffin wax (having its melting point at 72° C.). These compositions of the mixed solution were dispersed for 60 minutes using CLEARMIX before the mixed solution was added. After all the dispersed solution was added, the resulted mixture was kept at 80° C. for 60 minutes. After once cooled down, it was heated again to 80° C. After it was heated to 80° C., solution composed of 100 parts by mass of ion-exchanged water and 2 parts by mass of potassium peroxodisulfate which was dissolved into that ion-exchanged water was placed into the reaction container. After 15 minutes, mixed solution composed of 130 parts by mass of styrene monomer, 32 parts by mass of butyl acrylate, 8.5 parts by mass of methacrylic acid and 3 parts by mass of n-octylmercaptan was delivered by drops into the reaction container in 90 minutes. After all the dispersed solution was added, the resulted mixture was kept at 80° C. for 60 minutes. Then, it was cooled down, and thereby dispersed solution of the resin particulates (v-4) of vinyl copolymer was obtained. The concentration of the solid content in the dispersed solution was 25% by mass. The average particle diameter of the particulates was 200 nm. A small amount of the dispersed solution was taken and placed on a petri dish, and then the dispersion media contained therein was evaporated to obtain solid tetrahydrofuran. The obtained solid tetrahydrofuran had a number average molecular weight of 11,500, mass average molecular weight of 20,000 and glass transition temperature (Tg) of 64 (C.

<Synthesization of Prepolymer>

Into the reaction container equipped with the cooling tube, the stirrer and the nitrogen introducing tube, 366 parts by mass of 1,2-propylene glycol, 566 parts by mass of terephthalic acid, 44 parts by mass of trimellitic anhydride and 6 parts by mass of titanium tetrabutoxide were placed and heated at 230° C. for 8 hours under an atmospheric pressure. Then, they were reacted under a reduced pressure in the range of 10 mmHg to 15 mmHg at 230° C. for 5 hours. Thereby medium polyester resin 1 was obtained. The thus obtained Medium polyester 1 had a number average molecular weight of 3,200, a weight average molecular weight of 12,000 and a glass transition temperature (Tg) of 55° C.

Subsequently, into the reaction container, 420 parts by mass of Medium polyester 1, 80 parts by mass of isophorone diisocyanate and 500 parts by mass of ethyl acetate were placed, and they were reacted at 100° C. for 5 hours to. Thereby Prepolymer 1 was obtained. The content of free isocyanate in prepolymer 1 was 1.34% by mass.

—Preparation of Masterbatch—

Using a HENSCHEL Mixer, 40 parts by mass of Legal 400 parts a carbon black (manufactured by Cabot Company Inc.), 60 parts by mass of RS-801 (polyester resin manufactured by SANYO Chemical Industries, having an acid value of 10 mgKOH/g, a mass average molecular weight of 20,000 and a glass transition temperature (Tg) of 64° C.) as a binder resin and 30 parts by mass of water were mixed. Thereby an aggregated pigment in which water is absorbed was obtained. The thus obtained aggregated pigment was kneaded using a two-roll kneading machine for 45 minutes. The surface temperature of the rolls of the machine were 130° C. Then, the thus obtained kneaded-article was pulverized into 1 mm particles using a pulverizer, and thereby Masterbatch 1 was obtained.

### Example 1

<Production of Pigment- and Wax-Dispersed Solution (Oil Phase)>

Into the reaction container equipped with the stirrer bar and the thermometer, 126 parts of the polyester resin (P-1), 42 parts of paraffin wax (having its melting point at 72° C.) and 438 parts of ethyl acetate were placed and dispersed. The thus obtained mixture was heated to 80° C. and kept at the temperature for 5 hours. Then, it was gradually cooled down to 30° C. in 1 hour. Then, 137 parts by mass of Masterbatch 1 was added into the mixture, and the mixture was further mixed for 1 hour. The mixture was then transferred to UltraViscosMill (a bead mill manufactured by IMEX CORPORATION). Using the machine under the following conditions—solution velocity of 1 kg/hour, peripheral velocity of 6 m/sec, filled with 80% by volume of 0.5 mm zirconia beads and 3 passes, the pigment and wax were dispersed. Material dissolved solution 1 was obtained. Then, 261 parts by mass of 70% by mass ethyl acetate solution of the polyester resin (P-1) was added to 372 parts by mass of the material dissolved solution 1. They were mixed using Three-One Motor (a mixer) for 2 hours. Thereby pigment- and wax-dispersed solution 1 was obtained.

Then, ethyl acetate was added to adjust the concentration of the solid content in the pigment- and wax-dispersed solution 1 at 50% by mass. The concentration was measured at 130° C. for 30 minutes.

<Preparation of Water Phase>

The following compositions were mixed and thereby milky liquid was obtained: the compositions were 838 parts by mass of ion-exchanged water; 40 parts by mass of hydrophilic dispersed solution of 25% by mass of organic resin particulates (copolymer of styrene-methacrylic acid-acrylic acid butyl-sodium salt of methacrylic acid sulfuric ester of ethyleneoxide adduct) for stabilizing dispersed state; 162 parts by mass of 50% by mass solution (Eleminole MON-7, manufactured by SANYO Chemical Industries) of dodecyldiphenylether sodium disulfonate; 202 parts by mass of aqueous solution of 1% by mass of carboxy methyl cellulose as a thickener; and 108 parts by mass of ethyl acetate. The thus obtained solution was water phase 1.

<Emulsification>

Then, 1.29 parts by mass of isophorone diamine was added as an amine to the total pigment- and wax-dispersed solution 1, and they were mixed using TK Homo Mixer (available from Tokushu Kika Kogyo Co., Ltd.) at 5,000 rpm for 1 minute. Into the mixer, 101 parts by mass of Prepolymer 1 was placed, and they were further mixed in the mixer at 5,000 rpm for 1 minute. Finally, 1,340 parts by mass of the water phase 1 was added thereto, and they were mixed at an appropriately adjusted rotation speed in the range of 8,000 rpm to 13,000 rpm for 20 minutes to obtain emulsified slurry 1.

<Desolventizing Agent>

The obtained emulsified slurry 1 was placed into a mixer equipped with thermometer and was then desolventized at 30° C. for 8 hours, thus dispersed slurry 1 was obtained.

<Depositing Particulates>

Into the dispersed slurry 1, 252 parts by mass of the dispersed solution of the resin particulates of vinyl copolymer (V-1) was added. Then, the thus obtained solution was heated to 65° C. in 30 minutes. The solution was kept at 65° C. while solution of 10 parts by mass of ion-exchanged water and 10 parts by mass of magnesium chloride 6-hydrate which was dissolved into that ion-exchanged water was added thereto little by little. After almost all particulates were deposited, the pH of the solution was adjusted to 5 by adding hydrochloride solution, and then it was heated to 80° C. The solution was cooled down for 2 hours, and thereby dispersed slurry 1-2 was obtained.

10<Cleaning and Drying>

After vacuum pressure-filtering 1,000 parts by mass of the dispersed slurry 1-2, cleaning was conducted as follows.

(1) 1,000 parts by mass of ion-exchanged water was added to the thus obtained filtered cake. They were mixed using TK homomixer at 12,000 rpm for 10 minutes, and then they were filtered.

(2) 1,000 parts by mass of ion-exchanged water was added to the filtered cake obtained in (1). They were mixed using TK homomixer with ultrasonic vibration at 12,000 rpm for 30 minutes, and then they were vacuum pressure-filtered. Until electrical conductance of 10 μC/cm was obtained in reslurry solution, the operations of (1) and (2) were repeated.

(3) 10% by mass of hydrochloride was added in order to adjust the pH of the reslurry solution of (2) at 4, and then the resulted solution was mixed using Three-One Motor. After 30 minutes, it was filtered.

(4) 1,000 parts by mass of ion-exchanged water was added to the filtered cake obtained in (3). They were mixed using TK homomixer at 12,000 rpm for 10 minutes, and then they were filtered. Until electrical conductance of 10 μC/cm was obtained in reslurry solution, the operations of (3) and (4) were repeated to thereby obtain filtered cake 1.

The thus obtained filtered cake 1 was dried using a shield type dryer at 45° C. for 48 hours, and sieved with a mesh having openings of 75 μm to obtain toner base particles 1. The obtained toner base particles had a volume average particle diameter (Dv) of 6.4 μm, a number average particle diameter (Dn) of 5.7 μm, the ratio of Dv to Dn of 1.12 and an average circularity of 0.972. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 1 was obtained.

### Example 2

Developer 2 was obtained in the same manner as in Example 1 except that the resin particulates (V-2) of vinyl copolymer were used instead of the resin particulates (V-1) of vinyl copolymer.

### Example 3

<Production of Pigment and Wax Dispersed Solution (Oil Phase)>

Material dissolved solution 1 was obtained in the same manner as in Example 1. Then, 273 parts by mass of 70% by mass ethyl acetate solution of the polyester resin (P-1) was added to 372 parts by mass of the material dissolved solution 1. They were mixed using Three-One Motor (a mixer) for 2 hours. Thereby pigment- and wax-dispersed solution 3 was obtained.

Then, ethyl acetate was added to adjust the concentration of the solid content in the pigment- and wax-dispersed solution 3 at 50% by mass. The concentration was measured at 130° C. for 30 minutes.

<Preparation of Water Phase>

Water phase 1 was obtained in the same manner as in Example 1.

<Emulsion Process>

Then, 0.5 parts by mass of isophorone diamine was added as an amine to the total pigment- and wax-dispersed solution 3, and they were mixed using TK Homo Mixer (available from Tokushu Kika Kogyo Co., Ltd.) at 5,000 rpm for 1 minute. Into the mixer, 1,340 parts by mass of the water phase 1 was added, and they were further mixed in the mixer at an appropriately adjusted rotation speed in the range of 8,000 rpm to 13,000 rpm for 20 minutes to thereby obtain emulsified slurry 3.

<Desolventizing Agent>

The obtained emulsified slurry 3 was placed into the mixer equipped with thermometer and was then desolventized at 30° C. for 8 hours, thus dispersed slurry 3 was obtained.

<Depositing Particulates>

Into the dispersed slurry 3, 422 parts by mass of the dispersed solution of the resin particulates of vinyl copolymer (V-1) was added. They were heated to 65° C. in 30 minutes. The solution was kept at 65° C. while solution of 15 parts by mass of ion-exchanged water and 15 parts by mass of magnesia chloride 6-hydrate which was dissolved into that ion-exchanged water was added thereto little by little. After almost all particulates were deposited, the pH of the solution was adjusted to 5 by adding hydrochloride solution, and then it was heated to 80° C. The solution was cooled down for 2 hours, and thereby dispersed slurry 3-2 was obtained.

Toner base particles 3 were obtained in the same manner as in Example 1. The obtained toner base particles had a volume average particle diameter (Dv) of 6.2 μm, a number average particle diameter (Dn) of 5.6 μM, the ratio of Dv to Dn of 1.11 and an average circularity of 0.974. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 3 was obtained.

### Example 4

Developer 4 was obtained in the same manner as in Example 3 except that the resin particulates (V-2) of vinyl copolymer were used instead of the resin particulates (V-1) of vinyl copolymer.

### Example 5

<Production of Pigment and Wax Dispersed Solution (Oil Phase)> Into the reaction container equipped with the stirrer bar and the thermometer, 126 parts of the polyester resin (P-2), 42 parts of paraffin wax (having its melting point at 72° C.) and 438 parts of ethyl acetate were placed and mixed at 80° C. The thus obtained mixture was kept at 80° C. for 5 hours. Then, it was gradually cooled down to 30° C. in 1 hour. Then, 137 parts by mass of Masterbatch 1 was added into the mixture, and the mixture was further mixed for 1 hour. The mixture was then transferred to a bead mill (UltraViscos Mill, manufactured by IMEX CORPORATION). Using the machine under the following conditions—solution velocity of 1 kg/hour, peripheral velocity of 6 m/sec, filled with 80% by volume of 0.5 mm zirconia beads and 3 passes, the pigment and wax were dispersed. Thus material dissolved solution 5 was obtained. Then, 281 parts by mass of 70% by mass ethyl acetate solution of the polyester resin (P-2) was added to 372 parts by mass of the material dissolved solution 5. They were mixed using Three-One Motor (a mixer) for 2 hours. Thereby pigment- and wax-dispersed solution 5 was obtained.

Then, ethyl acetate was added to adjust the concentration of the solid content in the pigment- and wax-dispersed solution 5 at 50% by mass. The concentration was measured at 130° C. for 30 minutes.

<Preparation of Water Phase>

Water phase 1 was obtained in the same manner as in Example 1.

<Emulsion Process>

Then, 1.35 parts by mass of isophorone diamine was added as an amine to the total pigment- and wax-dispersed solution 5, and they were mixed using TK Homo Mixer (available from Tokushu Kika Kogyo Co., Ltd.) at 5,000 rpm for 1 minute. Into the mixer, 106 parts by mass of Prepolymer 1 was placed, and they were further mixed in the mixer at 5,000 rpm for 1 minute. Finally, 1,340 parts by mass of the water phase 1 was added thereto, and they were mixed at an appropriately adjusted rotation speed in the range of 8,000 rpm to 13,000 rpm for 20 minutes to obtain emulsified slurry 5.

<Desolventizing Agent>

The obtained emulsified slurry 5 was placed into the mixer equipped with thermometer and was then desolventized at 30° C. for 8 hours, thus dispersed slurry 5 was obtained.

<Depositing Particulates>

Into the dispersed slurry 5, 281 parts by mass of the dispersed solution of the resin particulates of vinyl copolymer (V-1) was added. They were heated to 65° C. in 30 minutes. The solution was kept at 65° C. while solution of 10 parts by mass of ion-exchanged water and 10 parts by mass of magnesia chloride 6-hydrate which was dissolved into that ion-exchanged water was added thereto little by little. After almost all particulates were deposited, the pH of the solution was adjusted to 5 by adding hydrochloride solution, and then it was heated to 80° C. The solution was cooled down for 2 hours, and thereby dispersed slurry 5-2 was obtained.

Then, toner base particles 5 were obtained in the same manner as in Example 1. The obtained toner base particles had a volume average particle diameter (Dv) of 6.0 μm, a number average particle diameter (Dn) of 5.4 μm, the ratio of Dv to Dn of 1.11 and an average circularity of 0.975. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 5 was obtained.

### Example 6

<Production of Pigment Dispersed Solution>

Into 876 parts by mass of ion-exchanged water, 24 parts by mass of 50% by mass solution (Eleminole MON-7, manufactured by SANYO Chemical Industries) of dodecydiphenylether sodium disulfonate and 100 parts by mass of carbon black (Legal 400R, manufactured by Cabot Ltd.) were added. They were mixed using Three-One-Motor for 1 hour, and then pigment dispersed solution was obtained using UltraViscos (a beads mill manufactured by IMEX CORPORATION). The thus obtained solution was pigment dispersed solution 6.

<Production of Wax Dispersed Solution>

Into 810 parts by mass of ion-exchanged water, 40 parts by mass of 50% by mass solution (Eleminole MON-7, manufactured by SANYO Chemical Industries) of dodecydiphenylether sodium disulfonate and 150 parts by mass of paraffin wax (having its melting-point at 72 C. °) were added. They were mixed using Three-One-Motor for 1 hour, and then wax dispersed solution was obtained using UltraViscos (a beads mill manufactured by IMEX CORPORATION). The thus obtained solution was wax dispersed solution 6.

<Granulation (Aggregation) of Core Particle>

Into the mixer equipped with thermometer, the following compositions were placed: 140 parts by mass of ion-exchanged water, 2 parts by mass of dodecyl sodium sulfate, 800 parts by mass of dispersed solution of resin particulates (V-3) of vinyl copolymer, 163 parts by mass of pigment dispersed solution 6 and 83 parts by mass of wax dispersed solution 6. The pH of the mixture was adjusted at 10 by adding 2% by mass solution of sodium hydroxide. Then, solution of 8 parts by mass of ion-exchanged water and 8 parts by mass of polyaluminum chloride which was dissolved into that ion-exchanged water was added to the mixture little by little while it was stirred and kept at 50° C. Immediately after the diameters of aggregated particles reached 6.0 μm, the mixture was proceeded to the next process. The thus obtained liquid was water dispersed slurry 6.

<Depositing Particulates>

Into the dispersed slurry 6, 150 parts by mass of dispersed solution of resin particulates (V-1) of vinyl copolymer was added, and they were heated to 65° C. After almost all particulates were deposited, the pH of the solution was adjusted to 5 by adding hydrochloride solution, and then it was heated to 80° C. The solution was cooled down for 2 hours, and thereby dispersed slurry 6-2 was obtained.

Material dissolved solution 6 was obtained in the same manner as in Example 1. The obtained toner base particles had a volume average particle diameter (Dv) of 6.5 μm, a number average particle diameter (Dn) of 5.7 μm, the ratio of Dv to Dn of 1.14 and an average circularity of 0.968. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 6 was obtained.

### Example 7

<Granulation (Aggregation) of Core Particle>

Into the mixer equipped with thermometer, the following compositions were placed: 1200 parts by mass of ion-exchanged water, 2 parts by mass of dodecyl sodium sulfate, 890 parts by mass of dispersed solution of resin particulates (V-4) of vinyl copolymer and 163 parts by mass of pigment dispersed solution 6. The pH of the mixture was adjusted at 10 by adding 2% by mass solution of sodium hydroxide. Then, solution of 40 parts by mass of ion-exchanged water and 40 parts by mass of magnesium chloride 6-hydrate which was dissolved into that ion-exchanged water was added to the mixture little by little while it was stirred and heated to 80° C. The mixture was kept at 80° C., and immediately after the diameters of aggregated particles reached 6.0 μm, the mixture was preceded to the next process. The thus obtained liquid was water dispersed slurry 7.

<Depositing Particulates>

Into the dispersed slurry 7, 110 parts by mass of dispersed solution of resin particulates (V-2) of vinyl copolymer was added, and they were heated to 80° C. After almost all particulates were deposited, the pH of the solution was adjusted to 5 by adding hydrochloride solution, and then it was heated to and kept at 80° C. The solution was cooled down for 2 hours, and thereby dispersed slurry 7-2 was obtained.

Toner base particles 7 were obtained in the same manner as in Example 1. The obtained toner base particles had a volume average particle diameter (Dv) of 6.3 μm, a number average particle diameter (Dn) of 5.5 μm, the ratio of Dv to Dn of 1.15 and an average circularity of 0.969. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 7 was obtained.

### Comparative Example 1

Developer 8 was obtained in the same manner as in Example 1 except that the resin particulates (V-3) of vinyl copolymer were used instead of the resin particulates (V-1) of vinyl copolymer.

### Comparative Example 2

Developer 9 was obtained in the same manner as in Example 2 except that the resin particulates (V-3) of vinyl copolymer were used instead of the resin particulates (V-1) of vinyl copolymer.

### Comparative Example 3

<Production of Pigment and Wax Dispersed Solution (Oil Phase)>

Material dissolved solution 1 was obtained in the same manner as in Example 1. Then, 338 parts by mass of 70% by mass ethyl acetate solution of the polyester resin (P-1) was added to 372 parts by mass of the material dissolved solution 1. They were mixed using Three-One Motor (a mixer) for 2 hours. Thereby pigment- and wax-dispersed solution 1 was obtained.

Then, ethyl acetate was added to adjust the concentration of the solid content in the pigment- and wax-dispersed solution 1 at 50% by mass. The concentration was measured at 130° C. for 30 minutes.

<Preparation of Water Phase>

Water phase 1 was obtained in the same manner as in Example 1.

<Emulsion Process>

Then, 1.53 parts by mass of isophorone diamine was added as an amine to the total pigment- and wax-dispersed solution 1, and they were mixed using TK Homo Mixer (available from Tokushu Kika Kogyo Co., Ltd.) at 5,000 rpm for 1 minute. Into the mixer, 1,340 parts by mass of the water phase 1 was added, and they were further mixed in the mixer at an appropriately adjusted rotation speed in the range of 8,000 rpm to 13,000 rpm for 20 minutes to thereby obtain emulsified slurry 7.

<Desolventizing Agent>

The obtained emulsified slurry 10 was placed into the mixer equipped with thermometer and was then desolventized at 30 (C for 8 hours, thus dispersed slurry 10 was obtained.

<Cleaning and Drying>

The dispersed slurry 10 as processed in the same manner as in the dispersed slurry 1 in Example 1, and thereby toner base particles 10 were obtained. The obtained toner base particles had a volume average particle diameter (Dv) of 5.6 μm, a number average particle diameter (Dn) of 5.0 μm, the ratio of Dv to Dn of 1.12 and an average circularity of 0.980. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 10 was obtained.

### Comparative Example 4

Developer 11 was obtained in the same manner as in Example 1 except that the obtained dispersed slurry 11 was cooled without heated to 80° C. after the particulates were deposited.

### Comparative Example 5

To obtain dispersed slurry 12-2, hydrochloride solution was added to adjust the pH of core base particles obtained in the same manner as in Example 7 at 5. The resin particles (V-2) of vinyl copolymer were not added. Then, they were kept at 80° C. for 2 hours and cooled down.

Toner base particles 12 were obtained in the same manner as in Example 1. The obtained toner base particles had a volume average particle diameter (Dv) of 6.1 μm, a number average particle diameter (Dn) of 5.3 μm, the ratio of Dv to Dn of 1.15 and an average circularity of 0.970. Then, 0.5 parts by mass of hydrophobitic silica having a primary particle diameter of 30 nm and 0.5 parts by mass of hydrophobitic silica having a primary particle diameter of 10 nm were added to 100 parts by mass of the toner base particles. They were mixed using a HENSCHEL Mixer, and thus developer 12 was obtained.

Characteristics of the thus obtained developers of Examples 1 to 7 and Comparative Examples 1 to 5 were evaluated as described below. The results are shown in Table 1.

<Evaluation of Electrostatic Chargeability>

Toners (developers) treated with an external additive were used in continuously image forming test with an image forming apparatus (IPSIO CX 2500 manufactured by Ricoh Company, Ltd.). In the test, a predetermined print pattern having a Black/White ratio of 6% was continuously printed under N/N environment (23° C., 45% RH). To evaluate the charged amount, toner particles on the development roller being used for printing the pattern were collected after 50 sheets were printed under the N/N environment, and the electrification amount of the particles were measured using an electrometer.

Evaluation Criteria

A: The charged amount was 30 μC/g or more

B: The charged amount was 25 μC/g or more and less than 30 μC/g

C: The charged amount was 20 μC/g or more and less than 25 μC/g

D: The charged amount was less than 20 μC/g

<Stress Resistance Evaluation>

Toners (developers) treated with an external additive were used in continuously image forming test with an image forming apparatus (ipsio CX 2500 manufactured by Ricoh Company, Ltd.). In the test, a predetermined print pattern having a Black/White ratio of 6% was continuously printed under N/N environment (23° C., 45% RH). To evaluate the charged amount, toner particles on the development roller being used for printing the pattern were collected after 2,000 sheets were printed, or an endurance test, under the N/N environment, and the electrification amount of the particles were measured using the electrometer. The difference between the charged amount of the particles after 50 sheet output and that of after 2,000 sheets output was evaluated.

Evaluation Criteria

A: Absolute value of the difference of the charged amounts was less than 5

B: Absolute value of the difference of the charged amounts was 5 μC/g or more and less than 10 μC/g

C: Absolute value of the difference of the charged amounts was 10° C./g or more and less than 15 μC/g

D: Absolute value of the difference of the charged amounts was 15 μC/g or more

<Evaluation of Stains on Image>

Toners (developers) treated with an external additive were used in continuously image forming test with an image forming apparatus (IPSIO CX 2500 manufactured by Ricoh Company, Ltd.). In the test, a predetermined print pattern having a Black/White ratio of 6% was continuously printed under N/N environment (23° C., 45% RH). The test pattern was printed on a sheet after 2,000 sheets were printed, or an endurance test, under the N/N environment. Then, degree of the stains on the printed sheet was evaluated. The degree of the stains was evaluated based on the existence of toner streaks on non-image areas, white streaks on image areas, black spots and white spots.

Evaluation Criteria

A: No Stains

B: 1 to 2 stains on image

C: 3 to 5 stains on image

B: 6 or more stains on image

<Evaluation of Separation Performance from Fixing Member>

Toners (developers) treated with an external additive were used in continuously image forming test with an image forming apparatus (IPSIO CX 2500 manufactured by Ricoh Company, Ltd.). In the test, A4 size sheets were fed sideways to be printed. On the sheets, a 3 mm by 36 mm rectangle image (adhesion amount of 11 g/m²) was printed, but the image was not fixed on the sheets. Then, the sheets were fed to the below described fixing apparatus. The images on the sheets were fixed at a temperature ranged by an increment of 10° C. from 115° C. to 175° C. to obtain temperature ranges in which images could be separated without causing offset. The thus obtained temperature ranges were evaluated using the following criteria. In the temperature range, sheets could easily be separated from the heating roller without causing offset. In the test, the used sheets had 45 g/m², horizontal fiber direction and were fed sideways. These conditions are disadvantageous in separating the sheets. The feeding speed of the fixing apparatus was 120 mm/sec.

A fixing apparatus employing a soft roller covered with a fluorine coating was used. More specifically, the heating roller 11 was 40 mm in diameter and had a 1.5 mm thick elastic layer composed of silicon rubber and a tetra fluoro ethylene-perfluoro alkylvinyl ether copolymer (PFA) layer on an aluminum core shaft. A heater is contained in the aluminum core shaft. A pressure roller used was 40 mm in diameter and had a 1.5 mm thick elastic layer composed of silicon rubber and a tetra fluoro ethylene-perfluoro alkylvinyl ether copolymer (PFA) layer on an aluminum core shaft. The sheets having a printed image to be fixed will were fed as shown in FIG. 3.

Evaluation Criteria

A: sheets could be separated from the heating roller without causing offset in 115° C. to 175° C., and fixed images had an excellent endurance.

B: sheets could be separated from the heating roller without causing offset in 115° C. to 175° C., while fixed images were easily peeled off/scratched by scratching or rubbing.

C: sheets could be separated from the heating roller without causing offset in temperatures ranging 30° C. or more and less than 50° C.

D: sheets could be separated from the heating roller without causing offset in temperatures ranging less than 30° C.

<Heat-Resistant Storage Stability>

The toners were kept at 50° C. for 8 hours and sieved with a mesh having #42 openings for 2 minutes. Then, the amount of toner particles remaining on the mesh was measured to obtain the heat-resistant storage stability of the toners. The heat-resistant storage stability was evaluated using the following four criteria.

Evaluation Criteria

D: 30% or more of particles remained

C: 20% or more and less than 30% of particles remained

B: 10% or more and less than 20% of particles remained

A: less than 10% of particles remained

TABLE 1

| | | | | | | | | Shape | | | | | |
|---|---|---|---|---|---|---|---|---|---|---|---|---|---|
| | | Resin Composition | | | Toner Particle | | | Circu- | Evaluation | | | | |
| | | | | Shell | Diameter | | | larity | Electrostatic | Stress | Stains on | Separation | Heat-resistant |
| | Developer | Core | Shell | weight | Dv | Dn | Dv/Dn | degree | chargeability | resistance | image | Performance | storage property |
| Ex. 1 | 1 | P-1 | V-1 | 14% | 6.4 | 5.7 | 1.12 | 0.972 | B | A | A | A | A |
| Ex. 2 | 2 | P-1 | V-2 | 14% | 6.3 | 5.7 | 1.11 | 0.970 | B | A | A | A | A |
| Ex. 3 | 3 | P-1 | V-1 | 23% | 6.2 | 5.6 | 1.11 | 0.974 | A | A | A | B | A |
| Ex. 4 | 4 | P-1 | V-2 | 23% | 6.2 | 5.5 | 1.13 | 0.972 | A | A | B | B | A |
| Ex. 5 | 5 | P-2 | V-1 | 10% | 6.0 | 5.4 | 1.11 | 0.975 | B | A | B | A | A |
| Ex. 6 | 6 | V-3 | V-1 | 14% | 6.5 | 5.7 | 1.14 | 0.968 | B | B | B | B | B |
| Ex. 7 | 7 | V-4 | V-2 | 10% | 6.3 | 5.5 | 1.15 | 0.969 | B | B | B | B | B |
| Comp. Ex. 1 | 8 | P-1 | V-3 | 14% | 5.9 | 5.3 | 1.11 | 0.971 | C | C | B | B | B |
| Comp. Ex. 2 | 9 | P-1 | V-3 | 23% | 6.1 | 5.5 | 1.11 | 0.971 | C | C | A | B | B |
| Comp. Ex. 3 | 10 | P-1 | — | — | 5.6 | 5.0 | 1.12 | 0.980 | C | D | B | C | C |
| Comp. Ex. 4 | 11 | P-1 | V-1 | 14% | 6.3 | 5.6 | 1.13 | 0.943 | D | D | D | D | C |
| Comp. Ex. 5 | 12 | V-4 | — | — | 6.1 | 5.3 | 1.15 | 0.970 | C | C | C | D | C |

As the results shown in Table 1 indicate, the toners of Examples 1 to 7 showed favorable results. Particularly, the initial electrostatic chargeability of Examples 1 to 7 was excellent and durability thereof was generally favorable.

On the other hand, the toners of Comparative Examples 1 to 3 and 5, not containing layered inorganic mineral, had a good fixing ability and heat-resistant storage property, while had unfavorable durability.

Furthermore, the toner of Comparative Example 4, cooled down without heated to 80° C. after the resin particulates were deposited, had a particularly unfavorable characteristic. In addition, photoconductor filming was caused during the evaluation test. By observing the toner particles of Comparative Example 4, particle-shaped unevennesses, considered to be the resin particulates, were seen on the surface of the toner particles. Thus, it was confirmed that the resin particulates were not sufficiently thermally fixed.

What is claimed is:

1. A toner, comprising:
a core and a shell which covers the core,
wherein the core contains at least a colorant and a binder resin (A),
the shell contains at least a binder resin (B) and a modified-layered inorganic mineral obtained by modifying at least a part of interlayer ions of a layered inorganic mineral with organic ions,
the binder resin (A) contains at least a polyester resin, and
the binder resin (B) contains at least a vinyl copolymer resin.

2. The toner according to claim 1, wherein the shell is formed by aggregating and/or depositing and thermally fixing the modified-layered inorganic mineral and particulates containing the binder resin (B) on the core.

3. The toner according to claim 1, wherein the shell contains the modified-layered inorganic mineral obtained by modifying at least a part of the interlayer ions of the layered inorganic mineral with the organic ions.

4. The toner according to claim 1, wherein the modified-layered inorganic mineral is obtained by modifying at least a part of interlayer ions contained in one of silicates and hydrotalcites with the organic ions.

5. The toner according to claim 1, wherein the modified-layered inorganic mineral is obtained by modifying at least a part of interlayer ions of any one of montmorillonite, smectite and bentonite with organic cations.

6. The toner according to claim 5, wherein the organic cations are quaternary-ammonium cations.

7. The toner according to claim 2, wherein the particulates were polymerized by emulsion polymerization, miniemulsion polymerization or suspension polymerization in an environment to which at least the modified-layered inorganic mineral and a polymerizable compound are added.

8. The toner according to claim 1, wherein the core is obtained by dissolving and/or dispersing at least the polyester resin and the colorant in an inorganic solvent and dispersing the thus obtained dissolved or dispersed article into an aquatic medium.

9. The toner according to claim 1, wherein the core contains a modified polyester resin which contains at least one of urethane and urea groups.

10. The toner according to claim 1, wherein the polyester resin contains one of a modified polyester resin having an isocyanate group at a terminal thereof and a modified polyester resin chain-elongated or cross-linked by reaction of amines.

11. A production method for toner, comprising:
forming core particles by dispersing an organic solvent into which at least a polyester resin and a colorant are dissolved and/or dispersed into an aquatic medium,
depositing resin particulates of vinyl copolymer on the core particles by adding both an aquatic medium in which at least the resin particulates of vinyl copolymer and a modified-layered inorganic mineral are dispersed and a metal salt, and
heating the thus obtained toner particles.

12. The production method according to claim 11, wherein the core particles are formed by depositing and/or aggregating at least the resin particulates and the colorant in the aquatic medium, and thermally fixing the thus obtained particles.

13. The production method according to claim 11, wherein the glass transition temperature of a binder resin contained in the core particles is lower than the glass transition temperature of a binder resin contained in the shell.

14. A developer, comprising a toner, the toner comprising:
a core and a shell which covers the core,
wherein the core contains at least a colorant and a binder resin (A),
the shell contains at least a binder resin (B) and a modified-layered inorganic mineral obtained by modifying at least a part of interlayer ions of a layered inorganic mineral with organic ions,
the binder resin (A) contains at least a polyester resin, and
the binder resin (B) contains at least a vinyl copolymer resin.

15. A toner container, comprising a toner, the toner comprising:
a core and a shell which covers the core, wherein
the core contains at least a colorant and a binder resin (A),
the shell contains at least a binder resin (B) and a modified-layered inorganic mineral obtained by modifying at least a part of interlayer ions of a layered inorganic mineral with organic ions,
the binder resin (A) contains at least a polyester resin, and
the binder resin (B) contains at least a vinyl copolymer resin.

16. An image forming apparatus, comprising:
a latent electrostatic image bearing member,
a latent electrostatic image forming unit configured to form a latent electrostatic image on the latent electrostatic image bearing member,
a developing unit configured to develop the latent electrostatic image into a visible image using a toner,
a transfer unit configured to transfer the visible image onto a recording medium, and
a fixing unit configured to fix the transferred image on the recording medium,
wherein the toner comprises a core and a shell which covers the core,
the core contains at least a colorant and a binder resin (A),
the shell contains at least a binder resin (B) and a modified-layered inorganic mineral obtained by modifying at least a part of interlayer ions of a layered inorganic mineral with organic ions,
the binder resin (A) contains at least a polyester resin, and
the binder resin (B) contains at least a vinyl copolymer resin.

17. The image forming apparatus according to claim 16, wherein the fixing unit is equipped with a roller.

18. The image forming apparatus according to claim 16, wherein the fixing unit dose not apply oil.

19. A process cartridge, comprising:
a latent electrostatic image bearing member, and
a developing unit configured to develop a latent electrostatic image formed on the latent electrostatic image bearing member into a visible image using a toner,
and further integrally comprising at least one selected from a charging unit, cleaning unit and charge-elimination unit,
wherein the process cartridge is detachably attached to an image forming apparatus,
the toner comprises a core and a shell which covers the core,
the core contains at least a colorant and a binder resin (A),
the shell contains at least a binder resin (B) and a modified-layered inorganic mineral obtained by modifying at least a part of interlayer ions of a layered inorganic mineral with organic ions,
the binder resin (A) contains at least a polyester resin,
and the binder resin (B) contains at least a vinyl copolymer resin.
